(19) United States
(12) Patent Application Publication
(10) Pub. No.: US 2006/0242180 A1
(43) Pub. Date: Oct. 26, 2006

(54) Extracting data from semi-structured text documents

(76) Inventors: James A. Graf, New York, NY (US); Vladimir Koroteyev, Brooklyn, NY (US); Eduard Y. Mikhaylov, Forest Hills, NY (US); Elliot I. Bricker, New York, NY (US); Benjamin D. A. Levy, San Francisco, CA (US); Augustinus Y. Wong, Tenafly, NJ (US)

Correspondence Address: GRAY, PLANT, MOOTY, MOOTY & BENNETT, P.A., P.O. BOX 2906, MINNEAPOLIS, MN, 55402-0906, US

(21) Appl. No.: 10/565,611

(22) PCT Filed: Jul. 23, 2004
(86) PCT No.: PCT/US04/23932

§ 371 Date: Jan. 23, 2006

Related U.S. Application Data
(60) Provisional application No. 60/489,454, filed on Jul. 23, 2003.

(51) Int. Cl. G06F 17/00

(52) U.S. Cl. 707/101

(57) ABSTRACT

The invention is a process, system, and workflow for extracting and warehousing data from semi-structured documents in any language. This includes, but is not limited to, one or more of methods for: the automatic building of text mining term models; the optimization or evolution of such text mining term models; the implementation of document specific (or company specific) memory; and the tying or linking of the extracted data, or metadata, once placed in a target electronic document, to the machine readable, underlying source document, thus providing verification and provenance. The process preferably incorporates a wizard-based method for producing pattern recognition text mining term models to extract data from text. The invention also includes a system, method and workflow for handling a subsequent document of similar design and structure, specifically the automatic extraction of target elements and addition of the same to a database.

### CROSS-REFERENCE TO RELATED APPLICATION

This application claims the benefit of U.S. Provisional Patent Application No. 60/489,454 entitled “Method For Extracting Data From Semi-Structured Text Documents” as filed on Jul. 23, 2003.

### FIELD OF THE INVENTION

The invention relates to computer-based document data retrieval techniques known as text mining. It involves pattern recognition processes, including but not limited to those grouped under the umbrella of the field called evolutionary computation, as a means of optimizing fitness functions to locate data elements within similar type documents. The invention may also employ conventional text parsing techniques to locate data elements within text documents.

### SUMMARY OF INVENTION

The invention is a process, system, and workflow for extracting and warehousing data from semi-structured documents in any language. This includes, but is not limited to, one or more of methods for: the automatic building of text mining term models; the optimization or evolution of such text mining term models; the implementation of document specific (or company specific) memory; and the tying or linking of the extracted data, or metadata, once placed in a target electronic document, to the machine readable, underlying source document, thus providing verification and provenance. The process preferably incorporates a wizard-based method for producing pattern recognition text mining term models to extract data from text. The invention also includes a system, method and workflow for handling a subsequent document of similar design and structure, specifically the automatic extraction of target elements and addition of the same to a database. No previously defined rules or other rigid location specifying criteria regarding a particular document type need be expressed to mine this data.

Thus, in general terms, the invention may be described as a method for automatically extracting information from a semi-structured subsequent document. Each document may be characterized as a specific document type comprising certain design and structural characteristics of the document. It also contains terms having respective data element values. Beginning with at least one initial document of the same document type, that also contains desired terms having respective data element values, an extraction template is designed for the terms of the document type of each initial document. The terms of each initial document are matched to the extraction template, and then tagged according to the extraction template. Preferably facilitated by a wizard, a decision tree is automatically created to provide hierarchical selection criteria for determining the location of text. The hierarchy includes, but is not limited to, page, table, row, and column invariants or selectors. This decision tree is optimized using a regression model, and the optimized text mining term model is used to automatically extract information from the subsequent document. The text mining term model undergoes continual optimization to enhance performance.

### DESCRIPTION OF THE FIGURES

The Figures illustrate versions of preferred embodiments of various portions of the invention, and thus should be understood as being only schematic in nature and not illustrative of actual limitations on the scope of the invention as defined by issued claims.

FIG. 1 is a schematic view of a preferred embodiment of a user interface that facilitates the downloading of documents from a document source.

FIG. 2 is a schematic view of a preferred embodiment of a sample application launch page of the invention.

FIG. 3 is a schematic view of a preferred embodiment of a data collection and text mining term model building process preferred for use in the invention.

FIG. 4 is a schematic view of a preferred embodiment of a workflow chart, displaying the document management processes preferred for use in the invention.

FIG. 5 is a schematic view of a preferred embodiment of a user interface facilitating the design of an extraction template and further illustrating where in the data extraction process such design might occur.

FIG. 6 is a schematic view of a preferred embodiment of a process by which one or more data values may be tagged to the extraction template and further illustrating where in the data extraction process such tagging might occur.

FIG. 7 is a schematic view of a preferred embodiment of a preferred process by which a level of quality control is achieved by matching tagged values to expandable lists of accepted values or synonyms and further illustrating where in the data extraction process such quality control might occur.

FIG. 8 is a schematic view of a preferred embodiment of a process for constructing a text mining term model for each extracted term and further illustrating where in the data extraction process such construction might occur.

FIG. 9 is a schematic view of a preferred embodiment of an administration tool that allows for management of user roles and permissions in the use of the invention.

FIG. 10 is a schematic view of a preferred embodiment of a process for managing parameters such as user permissions, status, and identification.

FIG. 11 is a schematic view of a preferred embodiment of a portion of the invention, specifically a user interface to facilitate the design of an extraction template, illustrating an example of an extraction template for an SEC 10-Q document.

FIG. 12 is a schematic view of a preferred embodiment of a portion of the invention, specifically a user interface to facilitate the naming of a newly created extraction template.

FIG. 13 is a schematic view of a preferred embodiment illustrating terms desired for extraction as set forth in the extraction template.

FIG. 14 is a schematic view of a preferred embodiment of a visual indicator of a validation method illustrating that terms required for extraction have been extracted.

FIG. 15 is a schematic view of a preferred embodiment of visual indicators of a validation method illustrating required and non-required terms for extraction.

FIG. 16 is a schematic view of a preferred embodiment of a user interface facilitating the workflow processes associated with the document repository.

FIG. 17 is a schematic view of a preferred embodiment of an interface for insertion of a document into the invention.

FIG. 18 is a schematic view of a preferred embodiment of a user interface for the initiation of work on a document.

FIG. 19 is a schematic view of a preferred embodiment of an interface by which, for example, a document may be checked out, viewed, deleted, etc.

FIG. 20 is a schematic view of a preferred embodiment of a user interface by which the tagging process may be invoked.

FIG. 21 is a schematic view of a preferred embodiment of a user interface by which specific values for each term found in an extraction template may be tagged.

FIG. 22 is a schematic view of a preferred embodiment of a user interface by which the first term in the extraction template was tagged.

FIG. 23 is a schematic view of a preferred embodiment of a user interface illustrating a visual indicator that all terms required for extraction have been tagged.

FIG. 24 is a schematic view of a preferred embodiment of a user interface allowing for the maintenance of term classes and synonyms.

FIG. 25 is a schematic view of a preferred embodiment of a user interface illustrating a visual indicator that the tagged data value is not found within the accepted list of term data values.

FIG. 26 is a schematic view of a preferred embodiment of a user interface facilitating the expansion of the accepted list of term data values.

FIG. 27 is a schematic view of a preferred embodiment of the client/server architecture that may be employed in the invention.

FIG. 28 is a schematic view of a preferred embodiment of the lifecycle of the data extraction process of the invention and the insertion of such extracted data in database(s) and end-user applications.

FIG. 29 is a schematic view of an example of XML code containing the results of the extraction process.

FIG. 30 is a schematic view illustrating an example of the invention's source link technology used in conjunction with an end-user spreadsheet application.

FIG. 31 is a schematic view illustrating that an end user may follow the link of FIG. 30 back to the source document to find the page and highlighted location of the formerly extracted text.

FIG. 32 is a schematic view of a preferred embodiment of a user interface illustrating a term problem resolution module facilitating the addition of new values to the accepted list of term data values.

FIG. 33 is another schematic view of a preferred embodiment of a user interface illustrating that a new synonym has been added for the term value “Gold” to the accepted list of term data values.

FIG. 34 is a schematic view of a preferred embodiment of a user interface facilitating the building of text mining term models.

FIG. 35 is a schematic view of a preferred embodiment of a user interface by which a term is selected to design and build a text mining term model.

FIG. 36 is a schematic view of a preferred embodiment of a user interface illustrating the results of the creation of a decision tree.

FIG. 37 is a schematic view of a preferred embodiment of a user interface illustrating the results of the evaluation of the performance of a text mining term model in relation to a specific document.

FIG. 38 is a schematic view of a preferred embodiment of a user interface illustrating the performance of a text mining term model in relation to a training set of documents.

FIG. 39 is a schematic view illustrating an analogy of a genetic algorithm principle employed in preferred embodiments of the text mining term model optimization process of the invention.

FIG. 40 illustrates an embodiment of a wizard panel employed in preferred embodiments of the invention.

### DETAILED DESCRIPTION

The entirety of the following description of preferred embodiments of the invention should not be read as limitations on the invention, which is defined only by issued claims.

The invention provides for the automatic extraction and organization of information from documents in electronic format while retaining electronic links via a structured database to underlying source documents. In one embodiment of the invention, following conversion of data to a uniform data format, the invention is capable of extracting data from text originally in the form of, but not limited to, HTML, XML, PDF, ASCII Plain Text, plain text, or other formats that are first converted into such formats. The invention is capable of extracting data from text that is held within Double Byte Character Strings (DBCS) in addition to Single Byte Character Strings (SBCS).

The invention includes a workflow process that serves as a document management system and also augments any proprietary data warehouse management system with data crossover capabilities to proprietary systems. This data warehouse embodiment serves as the repository for extracted data.

The invention extracts data from these unstructured documents, by using text mining term models that utilize distance and language indicators that may be optimized using evolutionary algorithms utilized by the invention. The invention targets, but is not limited to, the optimization of finding best fit pattern indicators for text document data values. Applying statistical polynomial regression techniques optimized by methods preferably incorporated in the invention is one approach to the solution of producing pattern indicators used in the derivation and retrieval of text document data values.

A means of data extraction is first described whereby data is first imported into the system's optional document repository that serves as the training body or corpus of text. Note that the display screens and configuration of the graphical user interface (GUI) described below are provided in accordance with the presently preferred embodiment of the invention. However, such display screens and GUIs are readily modified to meet the requirements of alternative embodiments of the invention. The following discussion and accompanying screen shots is therefore provided for purposes of example and not as a limitation on the scope of the invention.

### Starting the Invention

The invention provides a server address and port for client connection. The stream socket connections to the server are pre-configured in the client application modules. As such, no address and port connection set-up is required by end-users as this configuration step is performed transparently. Launching any of the software modules of the invention will automatically perform the client connection to the server.

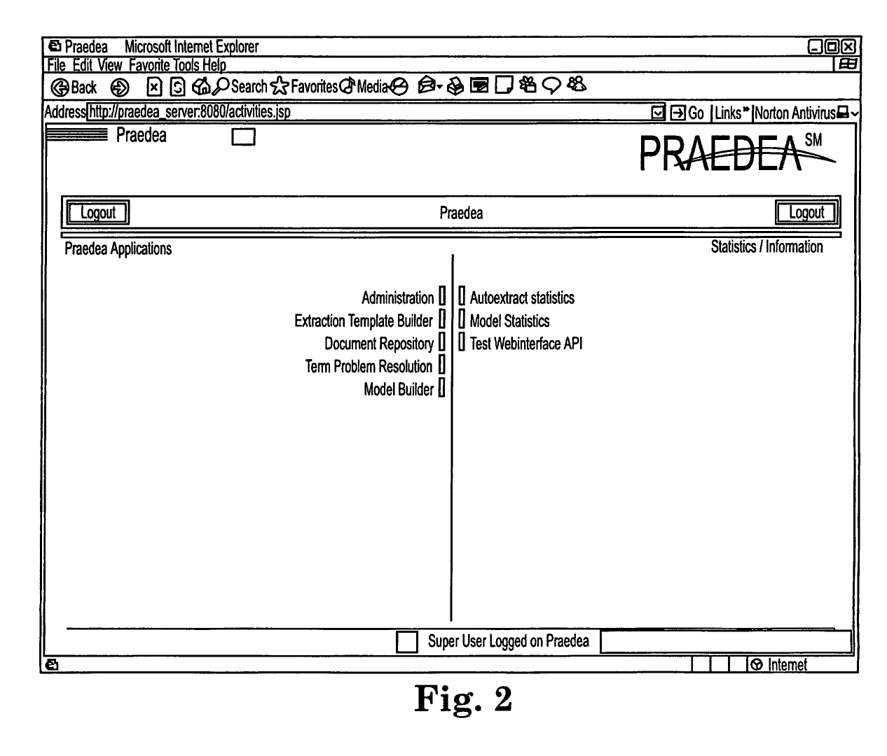

In order to launch the various application and report modules of the invention, a Web page is preferably incorporated on the server hosting the invention. The end-user simply launches this web page (see FIG. 2) and clicks on the appropriate link to launch the associated application.

### System Architecture Overview

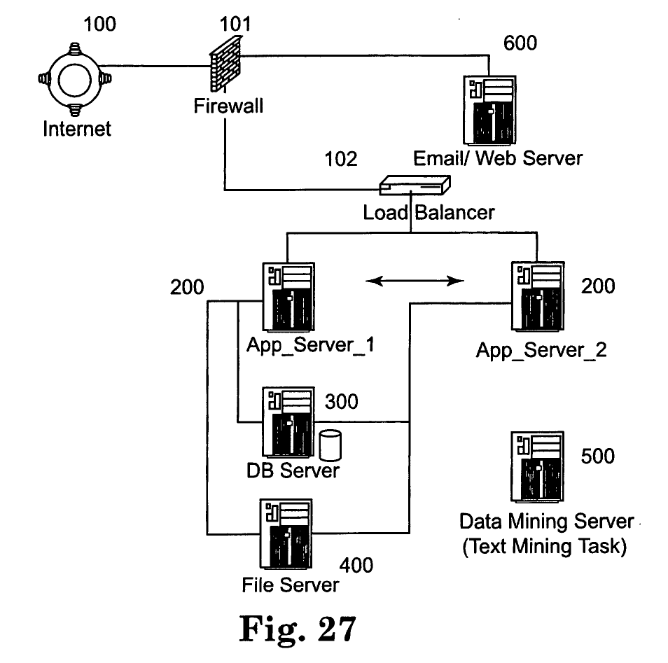

The invention operates on the principles of using a highly scalable server environment to support a plurality of clients. FIG. 27 is a schematic diagram illustrating the various components that make up the client/server computer architecture. In one embodiment of the invention, users use the various document management, structure design, and training dataset knowledge extraction GUIs via an Internet connection 100. The enterprise firewall 101 and proxy server infrastructures are respected by the system and various basic authentication procedures are in place to assure authenticity of gate application and feature use based on the permission granted to the logged on user. The enterprise may employ a hardware load balancer 102 in order to allow the clustering of two or more application servers 200 that serve as message conduits between the clients and the database 300 and file server 400. In addition, a separate server 500 may be provided in one embodiment of the invention so that the invention may be disconnected from the Internet enabled network 100 and configured to support the text mining term model building and deployment efforts described later. Another separate E-mail enabled server 600 is optionally employed by the invention to support notification and alert processes associated with the workflow processes.

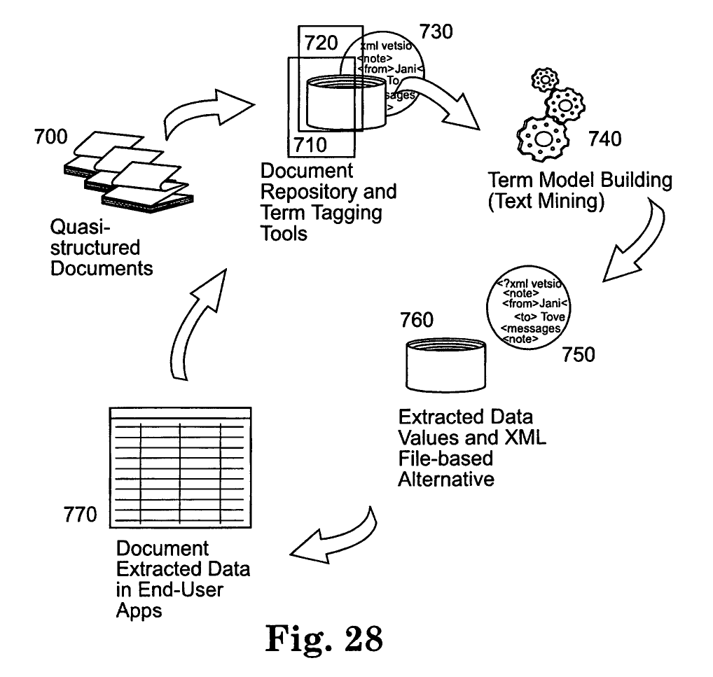

FIG. 28 is a schematic diagram illustrating the data flow starting with the introduction of source documents 700 to the system. The documents are preferably placed in a file server-based document repository 710 and the user tags the various data points to their appropriate named terms 720. An XML file 730 containing the page number and tagged data offsets positioned relative to the top of that page along with other metadata information about the tagged term is maintained by the invention. Additional information contained within the XML file 730 include, but are not limited to, table line item or heading strings, and the actual extraction data produced by the text mining algorithms inherent in the invention.

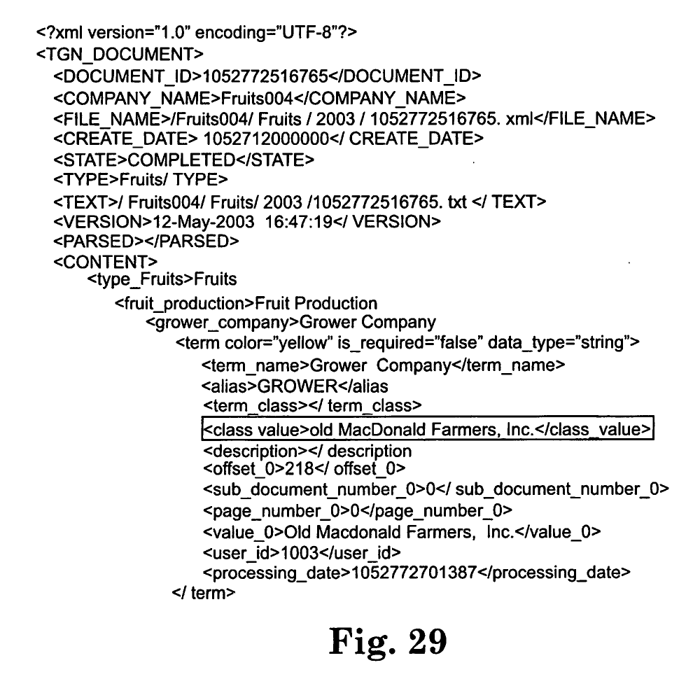

FIG. 29 shows a portion of a typical XML file. In FIG. 29, the term “Grower Company” has been tagged with value: “Old MacDonald Farmers, Inc.” Page number and offset information is represented as well. When a number of documents have had their term data values manually extracted (facilitated by the document repository module 720), the text mining term models can be automatically generated, preferably with use of a wizard. The outputs of running the text mining term model are XML files 750 containing term information such as data type, description, and other formatting information, as well as the extracted values that are the parameters used to optimize a polynomial regression model fitness function. These extracted values are preferably warehoused in a relational database management system (RDBMS) 760 used in conjunction with the invention (but typically not provided with the invention). End-user applications 770 may consume the extracted data as well as maintain links back to the source documents 700 as displayed in the document repository 710.

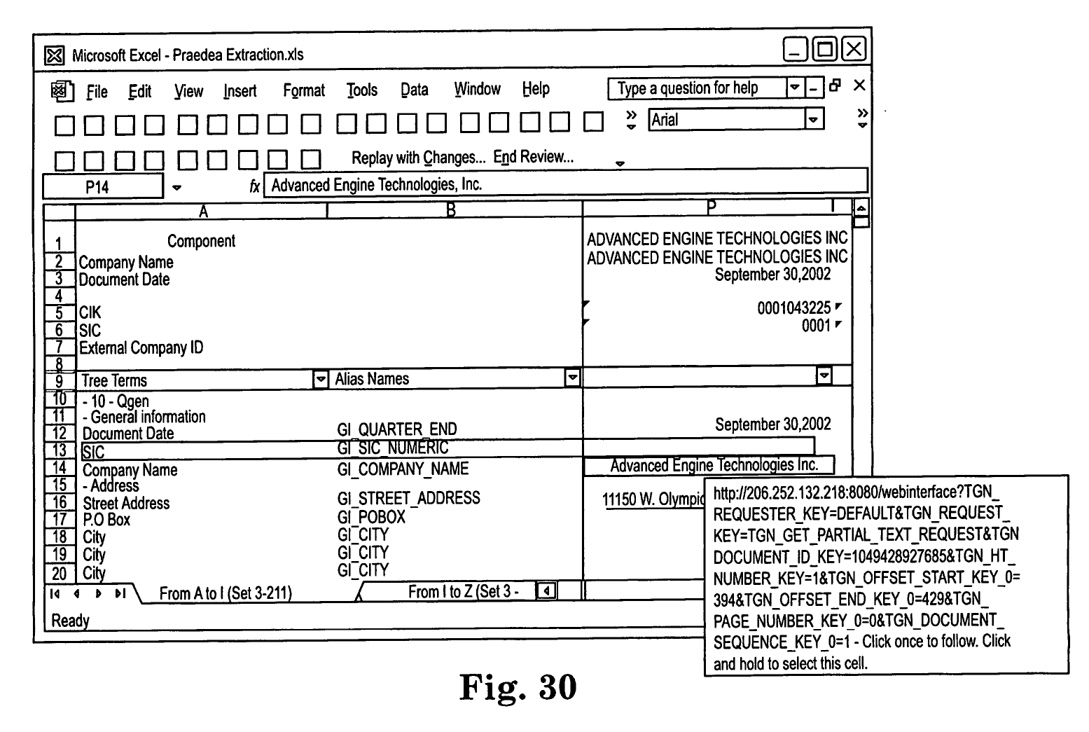

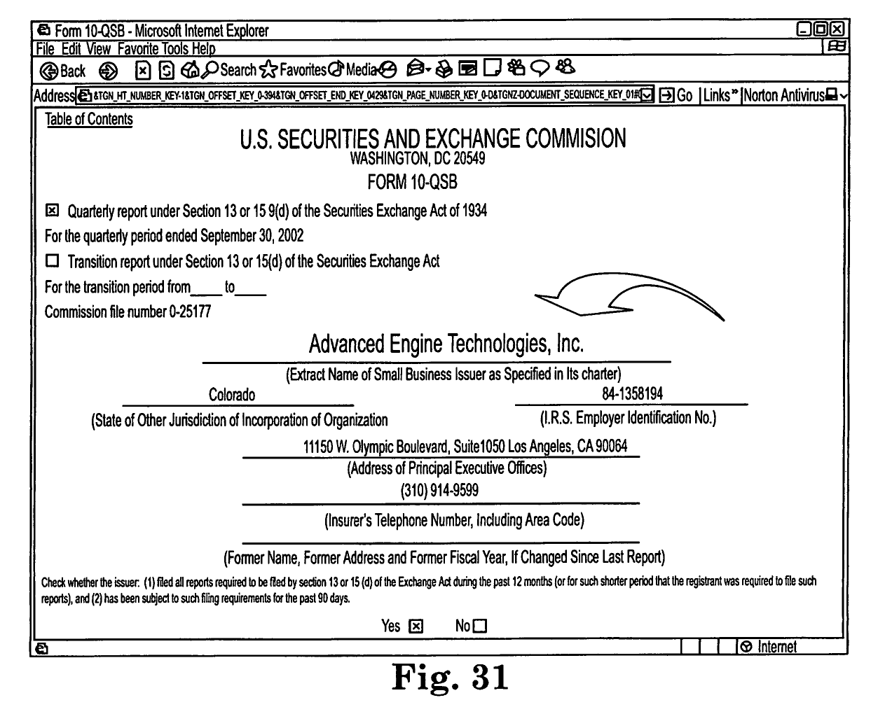

FIG. 30 depicts a sample end-user application (in this illustration, a spreadsheet known as Microsoft Excel®) containing links to the document repository 710. Information about document location (server and document unique identifier), page number, and tagged data value offset, along with other metadata, is maintained by the invention, enabling exposure of the source document to the user in one embodiment of a display mechanism inherent in the invention. This display is represented in FIG. 31. In addition to the aforementioned data, additional metadata may be collected for future use, including, but not limited to, row and column header strings, footnote information, name of the document, date and time stamp data, and other proprietary note or comment information, resulting in enriched content.

As illustrated in FIG. 31, the text within the source document is preferably displayed with some form of contrast (e.g., red highlighting), but in general any other suitable visual identifier for the actual text mining term model extracted value and relative location within the document may be used.

### Workflow for Data Extraction Process and High-Level Overview of Building Models

For explanatory purposes in the invention, the process of constructing and optimizing pattern recognition indicators to extract specific data elements from documents shall be noted as the process of building text mining “term models.” The invention preferably employs the following proprietary self-learning artificial intelligence and model optimization processes, which drive the text data extraction features of the invention.

In a preferred embodiment, the invention continuously re-evaluates and updates the text mining term models with each “completed” document so the invention is constantly learning and improving its performance in terms of for increased accuracy, when encountering future documents of the same type. A “completed” document is one tagged for each field or term of interest for extraction. The tagging of these terms/fields may be done manually (as described below), or automatically via pattern recognition analysis of the newly encountered document.

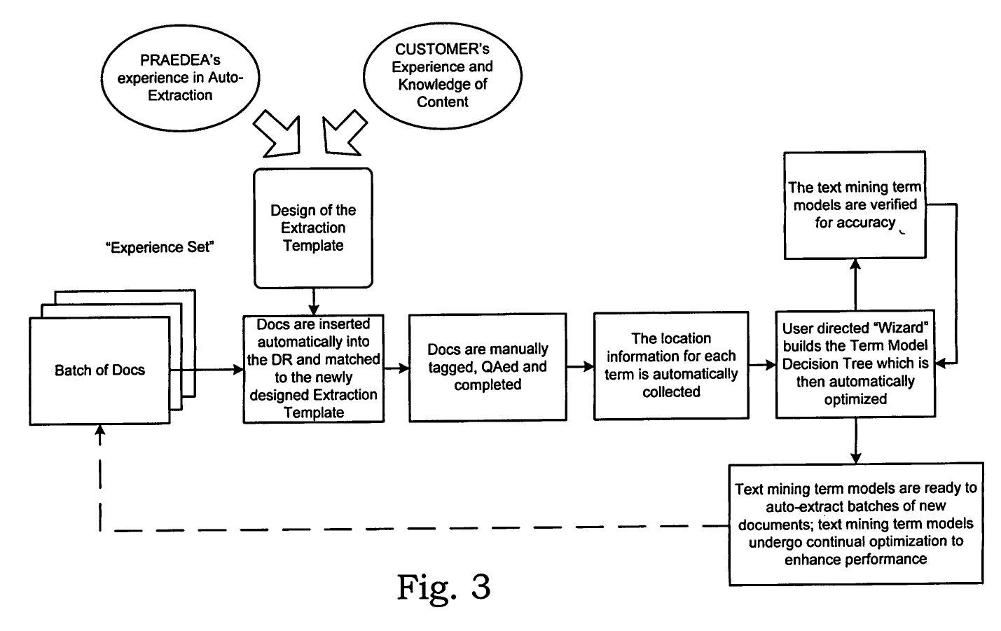

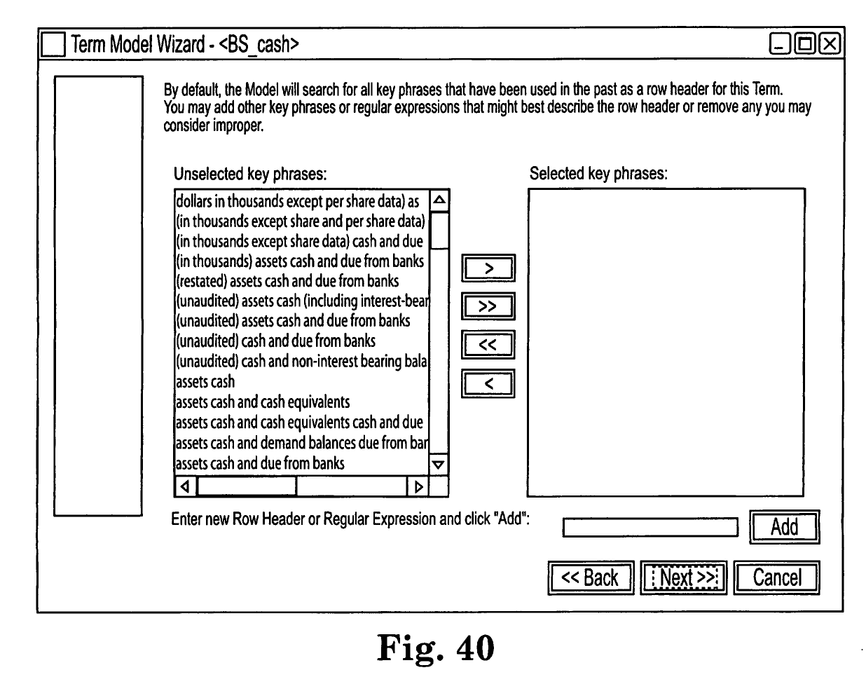

Documents are considered complete when they have been tagged for all the required terms/fields necessary to provide a single learning experience for location information. In one embodiment of the invention, this process is performed manually. A user locates the various data points in a document and maps that data to a pre-defined term name. The steps of the processes are:
1. A document is provided and a fixed number of specific terms or fields of interest are selected for extraction for the specific document type. This process is performed via the document structure client application of the invention and is denoted in FIG. 3 as “Design of the Extraction Template.” The invention allows an increase or decrease in the number of specified terms at a later time without loss of data integrity.
2. Documents of a specific type, i.e., those containing data that map to the selected terms identified in the previous step, are inserted automatically or manually into the document repository of the invention. This document repository may be implemented as an interface to a separate processor in the server-side topology, usually a separate processor in the server-side topology that is a file server. The document is called up and each term selected in the previous step is mapped to actual data values, e.g., by using highlight and click and other graphical user interfaces not critical to the scope of the invention. There is no programming experience needed in this or any other phase of the text mining term model building process. The manually tagged documents encompass the set of training or experience data needed for the text mining term model building process.
3. When a number of documents are tagged, the text mining term model builder module may be invoked to assist the user in creating pattern recognition models for each of the terms for the specific document type. The ideal number of documents in the so-called “experience set” will vary, depending on the variability of the presentation of the terms in those documents.
4. Text mining term models may be constructed either automatically or by building highly specific decision trees. For example, a wizard may be provided to guide construction of a decision tree. FIG. 40 illustrates an embodiment of a wizard panel. In this example, the panel offers an optional ability to select one or more of the accumulated “as-reported” column headers as search criteria for finding the term's value for a given term. In general, the wizard uses answers to questions about the structure of the document (which may be indicated by checked boxes, radio buttons and similar enacting actions of other user interface controls) to automatically construct the decision tree. For example, the wizard may ask whether a term's value is found within a table or appears as free text in the document. Other actions replicate the decision for other terms. Use of the wizard speeds the building of text mining term models, because the wizard may be run once for terms that have similar characteristics (e.g., terms that each reside in a table). The wizard may also schedule optimization of the ensuing models. Overall, use of a wizard may be preferred because of improved speed in the creation of text mining term models. In another variation on possible implementations of the wizard, completion of each panel of the wizard invokes a simulation of the user interface actions required by previous input to the wizard.
   Text mining term models are also preferably optimized through use of the invention. It is also preferred that the text mining term models are tested for quality control using a control group of documents, comprised of the same document type, that have not been processed by the system.
5. Text mining term models are then ready for batches of new documents that may now be extracted for their data points for the specified terms; such text mining term models undergo continual optimization to enhance performance. FIG. 3 shows a flow diagram of the text mining term model building process.

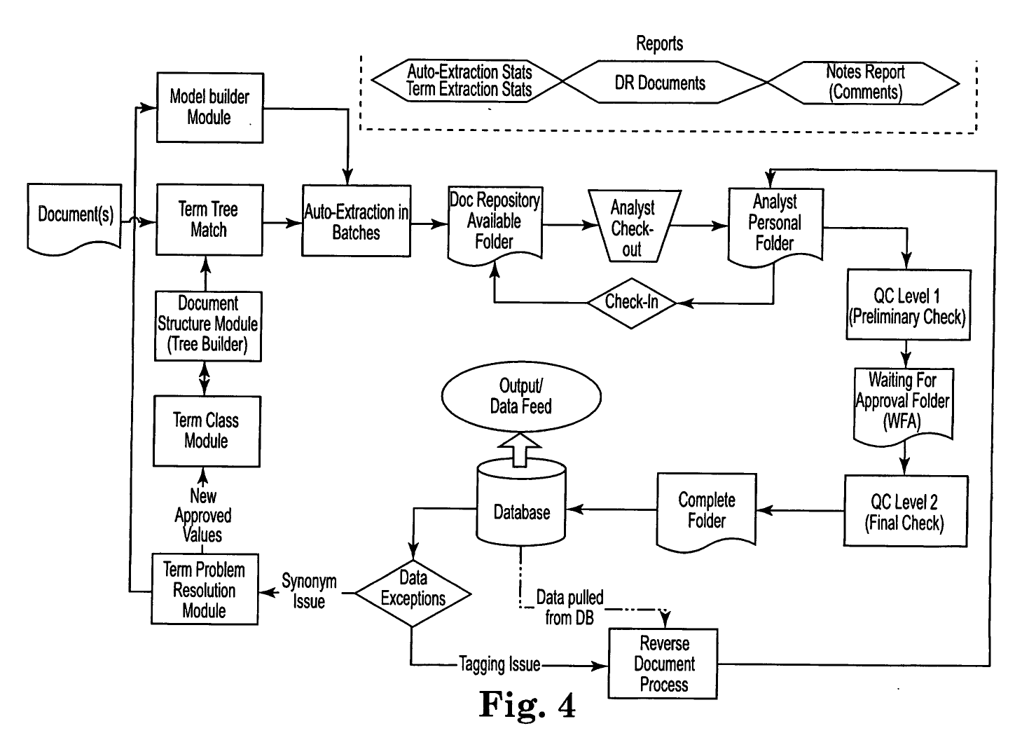

The invention provides a template for integrating document management into a workflow pattern. This workflow pattern can be tailored to the enterprise's specific needs. The following discussion describes a typical workflow process that allows documents to be migrated through the gamut of new document acquisition to the repository of extracted terms.
1. Documents may reach the invention via methods such as FTP and E-mail or a plurality of other data transfer means. Once the document arrives, it is associated with a specific extraction template.
2. If so configured, the document is auto-extracted, which means that the text mining term models extract the desired data points.
3. In one embodiment of the invention, the documents are placed into the document repository's Available Documents folder. This folder serves as a staging location for future document distribution as desired. Any document in an Available Documents folder for a specific document type may be checked out into a specific folder, e.g., “Your Checked-Out Documents” or (as illustrated in FIG. 4) an “Analyst Personal Folder.” The document management activities inherent in checking out and extracting a document are described in detail below.
4. In one embodiment of the invention, once the document is in a specific folder (such as “Your Checked-Out Documents”), the process of either manually tagging the correct data points to terms, or auto-extracting the document (which assumes that text mining term models have previously been created and are already available for the document type/extraction template), ensues.
5. In one embodiment of the invention, once the document is tagged with data associated to each desired term, the document's data point value-to-term name mapping is checked for accuracy (Quality Control Level 1, see FIG. 4). Based on administered security permissions, enacted by the user with the invention, the document is placed in either the “Waiting For Approval” or “Completed Documents” folder.
6. In one embodiment of the invention, if placed in the “Waiting For Approval” folder, the document is subject to inspection in a Quality Control Level 2 final check of the document (see FIG. 4). If the document passes inspection, it is considered complete.
7. In one embodiment of the invention, documents that have been tagged (and have optionally passed the quality control phase) are placed in the “Completed Documents” folder. In addition, the extracted term data point values are fed into both an XML file representation of the extraction template 750, as well as the relational database management system 760 (see FIG. 28).
   Assuming suitable permissions as described in step 6 above, a document may later be reversed, which clears the term data point values from the relational database management system and places the document into the processing flow, specifically into the original location or personal folder (e.g., “Your Checked-Out Documents”).

### Introduction to Client Application Modules

As was seen in the section Starting the Invention, above, a customizable Web page may be provided by the invention for launching the various applications of the invention, which include the administration, extraction tree structure definition, document workflow management, term problem resolution maintenance, and finally the text mining term model creation application. When the user clicks on one of the hyperlinks to select the appropriate module, the application module is launched. The invention may be deployed to the client and executed outside the scope of the Web browser.

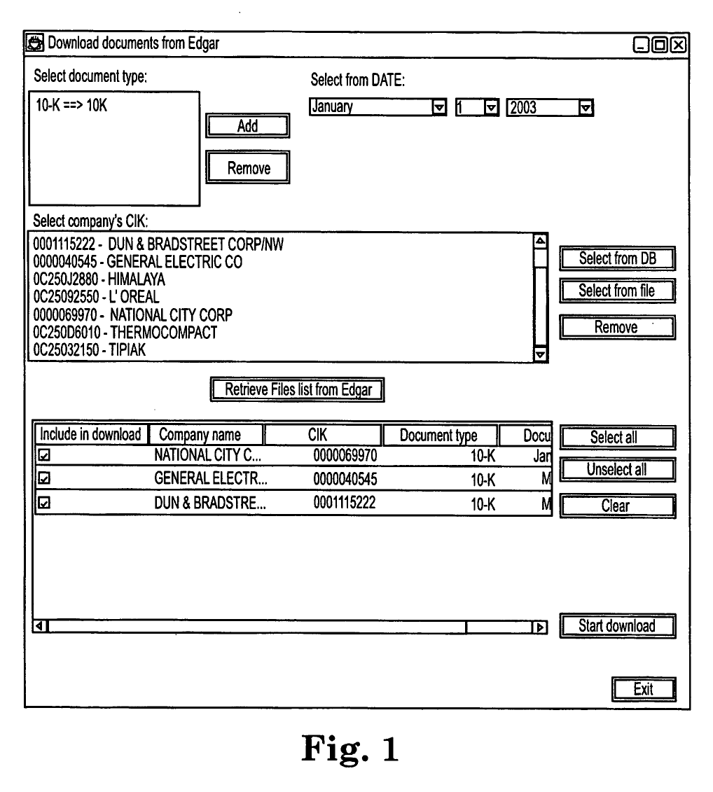

An example client application provides a GUI to allow users to facilitate the configuration of the movement of various documents from FTP sites that are widely available on the Internet. In the following embodiment of document retrieval, the U.S. Security and Exchange Commission's (SEC) FTP site is used as a source location for various financial documents that are housed in the EDGAR system. The invention contains logic that when applied to index information about available documents at this FTP site, will download a subset of documents for a given document type as of a specified date. FIG. 1 shows one embodiment of a GUI for this application.

### Describing a Document's Terms

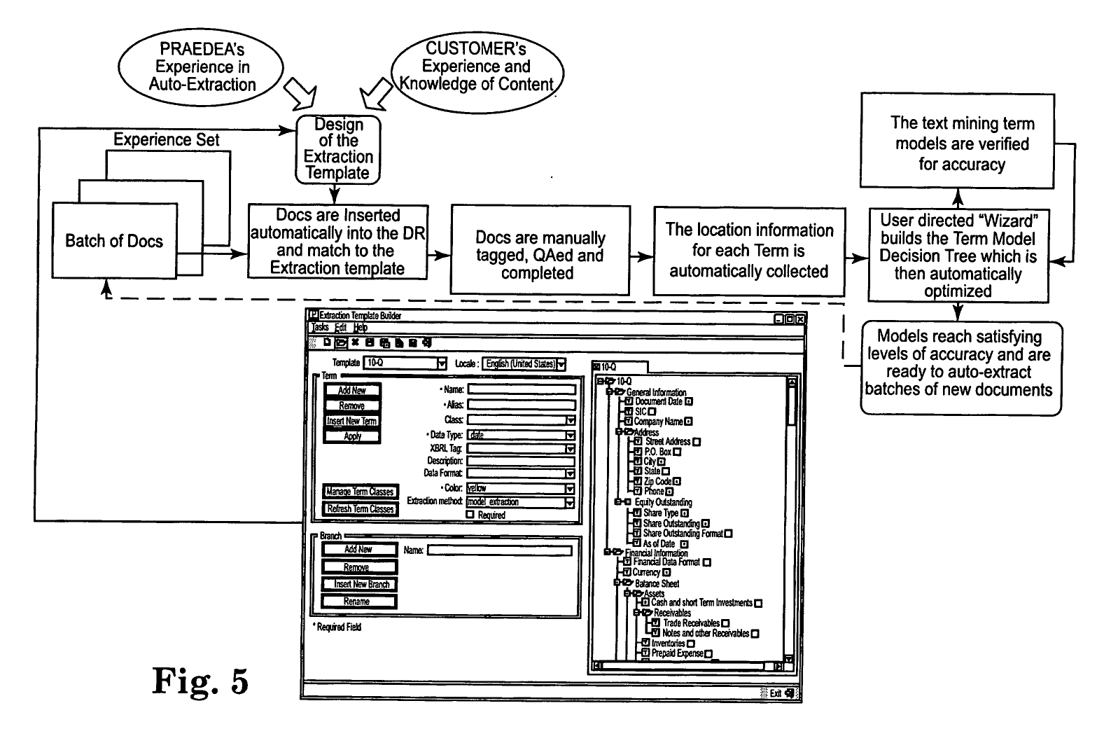

The diagrams in this section place the invention in the context of the overview of the data collection and text mining term model building process that was described in FIG. 3. FIG. 5 depicts the first activity of the process, which allows for the selection and description of term names for the data points desired to be extracted from a specific document type.

### Mapping Terms to Their Data Values

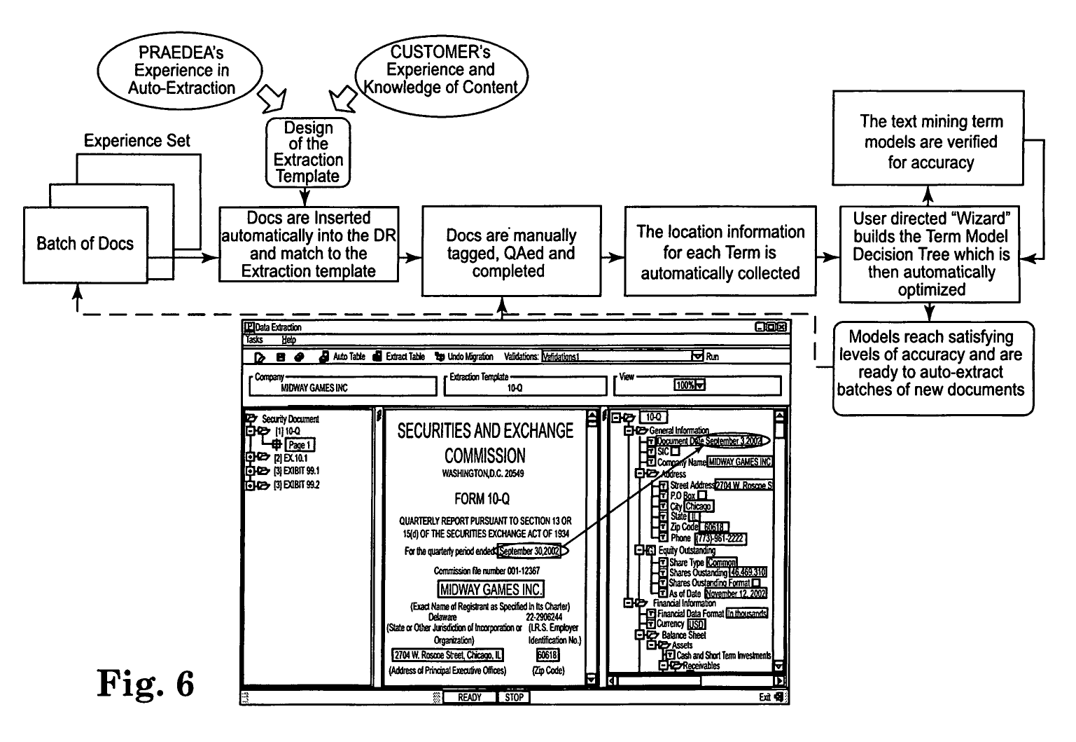

FIG. 6 depicts where in the process location context for the user interface used to map or tag data point values to those terms created using the Document Structure application.

### Term Validation

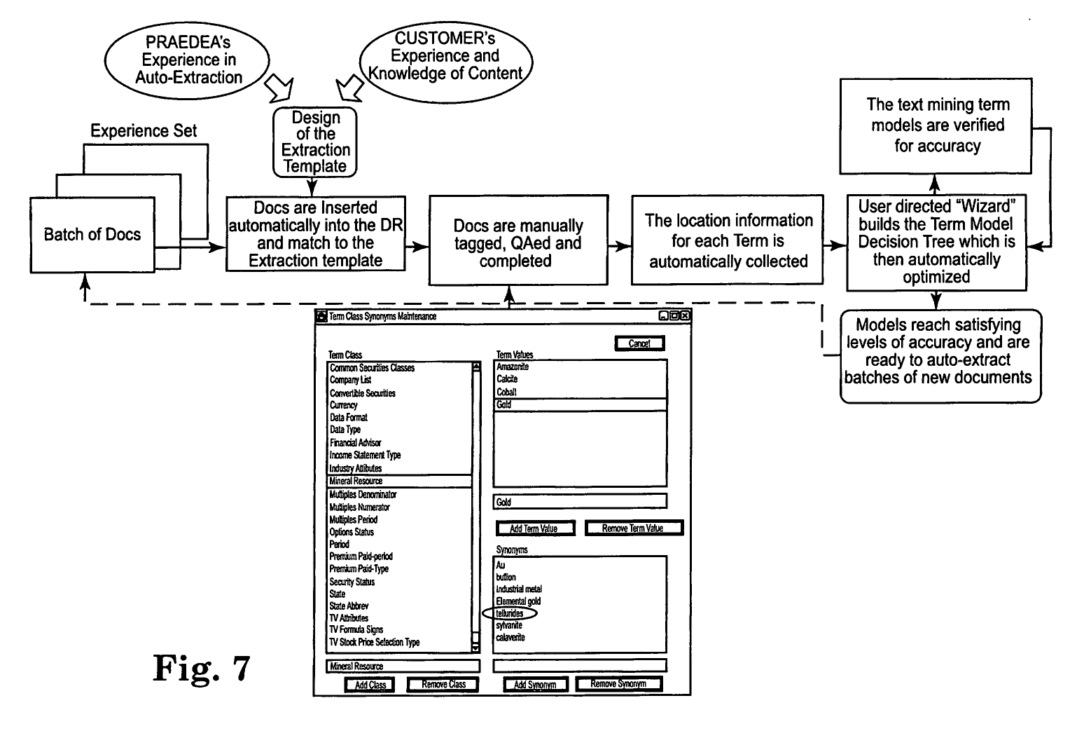

FIG. 7 depicts the process location context for the user interface used to create a list of acceptable term values for a specific class of a term. For example, if the name of a term is “Mineral Resource,” a diverse list of data point values may be mapped to this term such as amazonite, calcite, etc. These values for “Mineral Resource,” when mapped to the term name, are accepted as valid data point values. If the term value is not in the list of acceptable values for the term name, a dialog or similar process may warn of a possible quality-related problem with the extracted data.

### Building Text Mining Term Models

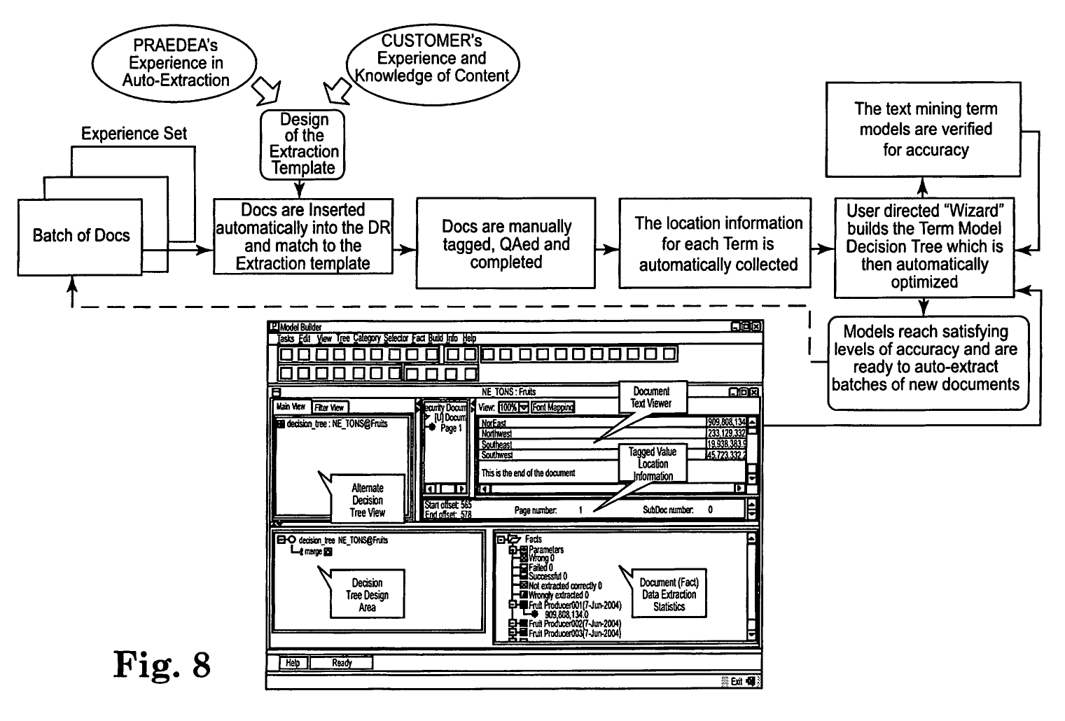

FIG. 8 depicts the process location context for the text mining term model creation step. Terms from a specific document type are selected and used to build the pattern recognition type of text mining term models-one per term. Creation of text mining term models is preferably done with a wizard so that that no prior engineering, programming or advanced computer skills are needed.

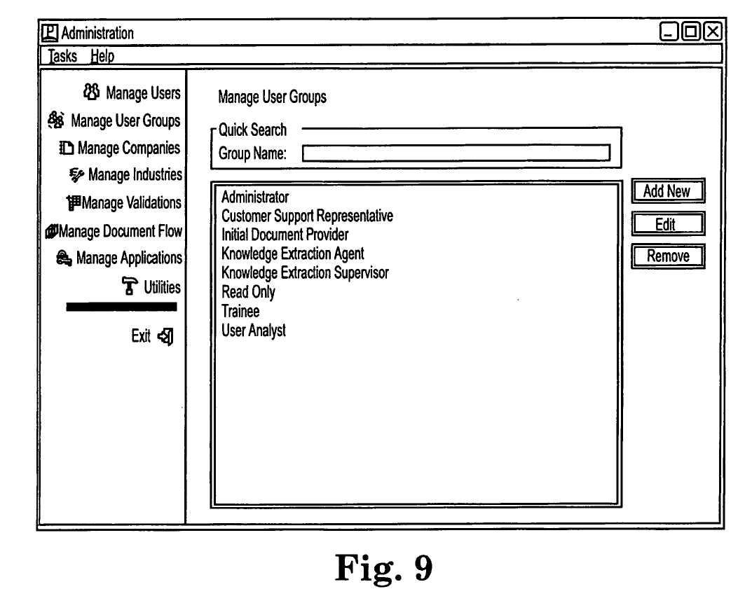

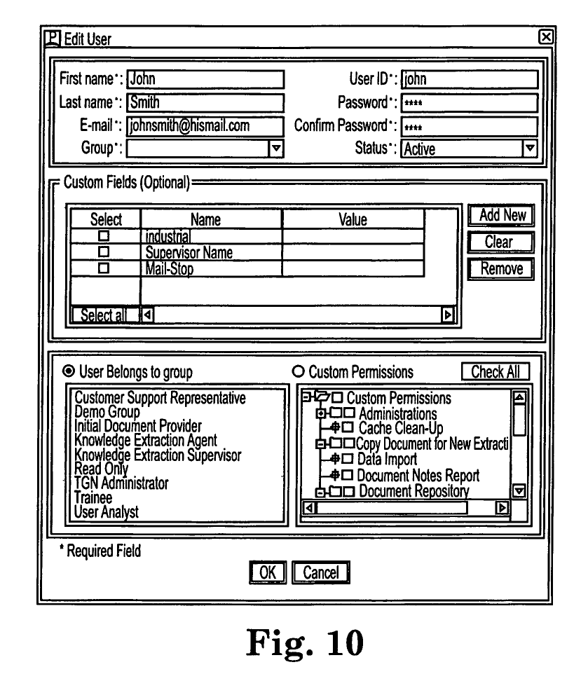

The administration module of the invention may be provided to manage the invention at all levels of organizational use including individuals and groups of users. Document management facilities may include the ability to administer information about associations that are made to documents. Examples of these associations may be, but are not limited to, the use of a company name, SIC and CIK codes, and the like. Additionally, if the internal (typically but not necessarily proprietary) systems of an enterprise assign unique identifiers to documents, the invention provides a method to map these keyed values to the documents held in the document repository. Another example of Administration Module use is the addition of new users to the invention as well as a plurality of administrative tasks such as permission granting, registration of names, e-mail addresses, etc. FIG. 9 shows an initial Administration Module panel with “Manage Groups” selected, which allows the assignment of individual users to predefined groups.

### Using the Document Structure Module

### Loading the Document Structure for a Pre-existing Document Type

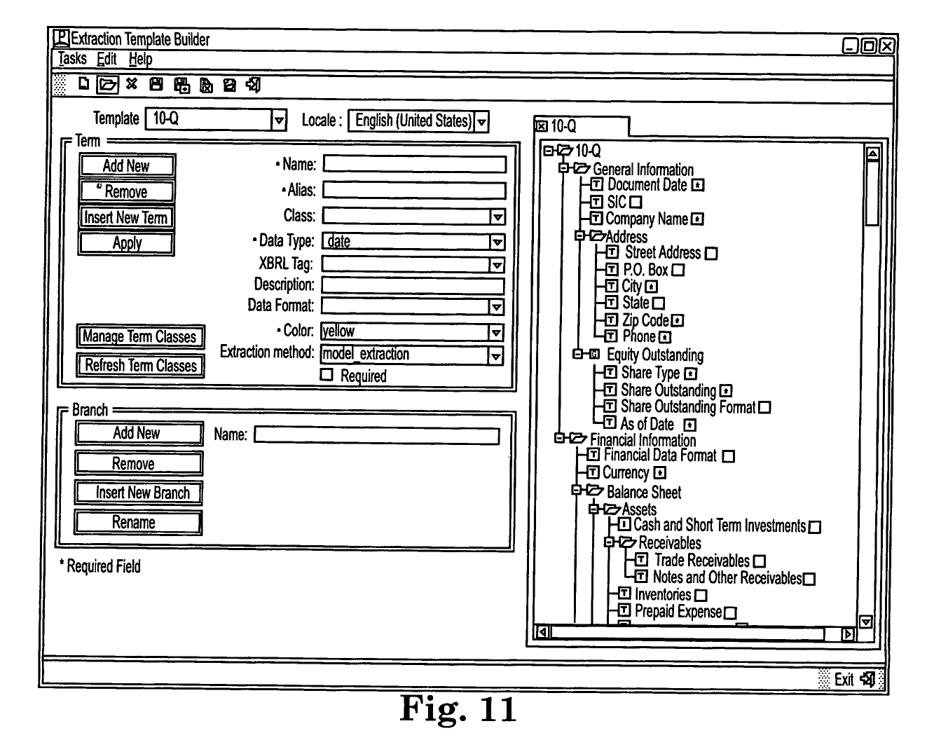

To identify each of the terms required for extraction to the invention, the user must design a extraction template that describes a taxonomy of term names as well as various attributes for each of the terms. FIG. 11 shows a sample extraction template representing the terms requested for extraction from a U.S. Securities and Exchange Commission Form 10-Q filing document. To display the user interface, the application may be launched from, for example, an extranet or Internet Web page, and the “Load” button associated to the current template (chosen from the drop down list) is selected.

### Creating a New Document Structure (Document Type/Extraction Template)

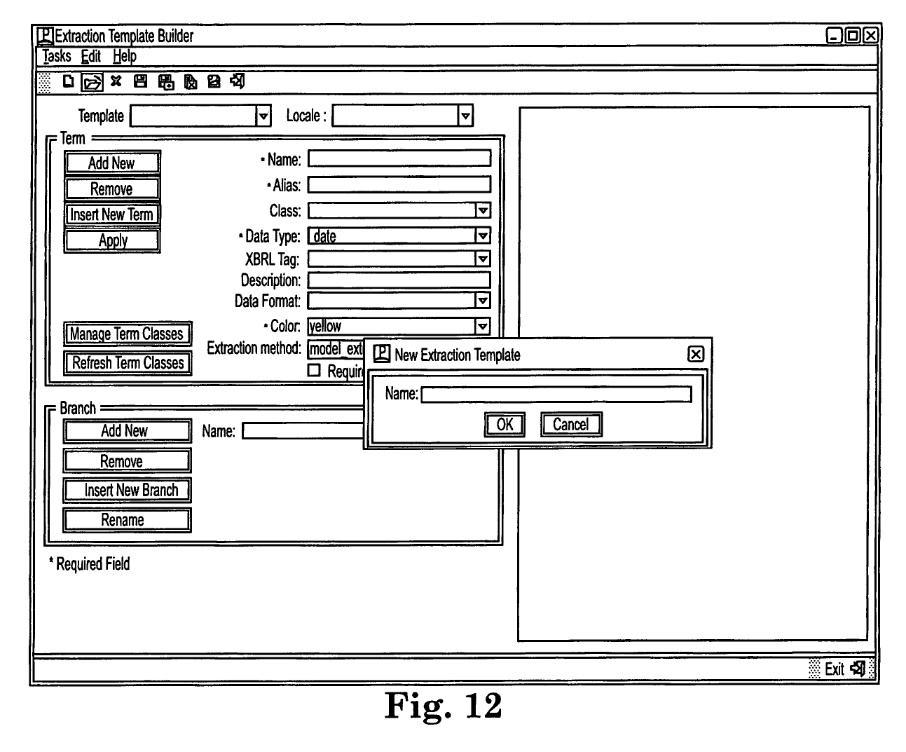

The user is presented with a screen such as that depicted in FIG. 12 upon initially launching the Document Structure program. To create a new extraction template, the user clicks the New button and enters an extraction template name. The initial folder presented in the extraction template contains the title of the template. The user can rename this folder at any time by clicking on the folder to select it and overtyping the branch name in its text field. To add the name representing a subsection of the document, the user highlights the root folder and enters a new branch name in the text box field “Branch Name.”

### Localization Support

In one embodiment of the invention, the user may find that the document type they are creating follows specific format constructs associated to a national language. The documents might be in a European language that requires some conforming data formats. For example, continental decimal notation (CDN) displays numbers using a comma to mark the decimal position and periods for separating significant digits into groups of three. For validation while tagging documents, the user may need to tell the system that the document type follows specific rules for date/time representations, numbers, character sets, character encodings, etc. The invention provides a locale combo box to choose the appropriate localization value (US is the default setting).

### Adding, Updating and Deleting Document Branches

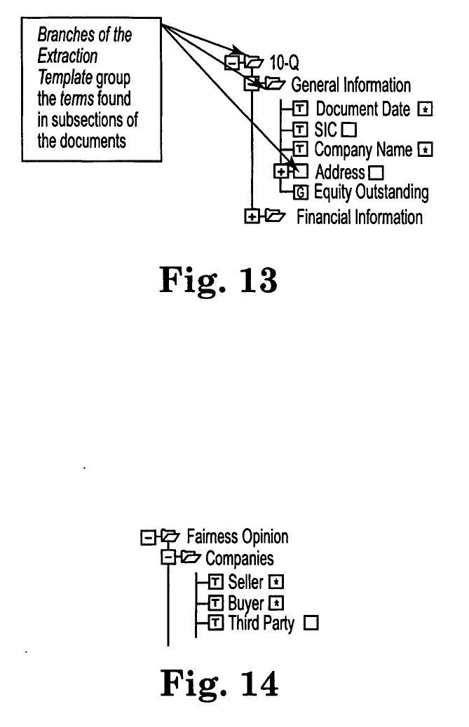

To add a branch to the extraction template, the user highlights a branch by clicking on it. Branches are represented in the extraction template as seen in FIG. 13. The user enters a name for the branch and clicks “Add Branch.” Branch names may have embedded blanks.

### Adding, Updating, Deleting, and Describing Document Terms

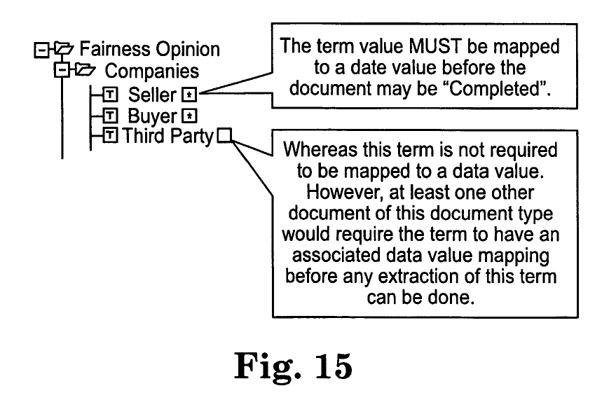

To add a term to the extraction template, the user may highlight a branch by clicking on it. The user enters the term name in the text field designated by the label “Name.” An asterisk (*) represents a field that is required. Embedded blanks are allowed for this name. The name is meant to represent a friendly name for the term. For example, when tagging the appropriate data, the data will be associated to the term name. The term may be presented in the extraction template along with a red question mark surrounded by a light blue box or any other suitable indication. The user enters an alias name. This name may be associated to a database column name in the invention's target repository of term values. This name is typically entered in upper case with underscore characters (_) used to represent blank characters. The user selects a term class type (optional). The term class name, when assigned to a term, is used to validate the tagged data point. The data point tagged in the document repository application must contain the text represented as a term value for the new term or synonym of the term value. The user selects a data type for the term (integer, string, double, date, or numeric). Optionally, the user may enters a description for the term. The user then selects a color that will be used during the term-to-data point value tagging process (document repository application). This color will be used to highlight the mapping of these elements. When running the document repository application, the actual document text will contain highlighted data values that will be mapped to each term name represented in a form of the extraction template that is built with the document structure application. The checkbox labeled “Required,” when checked, will assure that the term that appears in the document repository term-to-data point value mapping application is a term that must be mapped to a specific data value found in the document. It is not possible to “complete” the document via the document repository application if the required term is not tagged. The term may be indicated as required by any convenient means, such as selection of a “required” box for the term. FIG. 15 illustrates suitable visual indicators for required terms. The extraction template may be presented with a red question mark to indicate that this term must be tagged in order for the document to be used in the pool of training data documents.

### Structuring a Document's Terms in a Logical Hierarchy

When constructing the branches for the extraction template, it is desired to group sections of a document within a logical nesting of branches. If the document section is, for example, a table within a larger table and in turn within a text section, the branch for this sub-table may be several levels down in the hierarchy.

### Using the Document Repository Module

### Document Insertion

The document repository, in one embodiment of the invention, provides a GUI that allows the user to add individual documents that are to be extracted for data values associated to a template. In practice, documents are entered into the document repository by using automated loading facilities as discussed above. These might include scheduled downloads of plain text or HTML documents from, for example, the SEC using tools such as FTP. Upon launching the document repository tool, a suitable indication, such as an “insert” button, may include a new document for a specified document type.

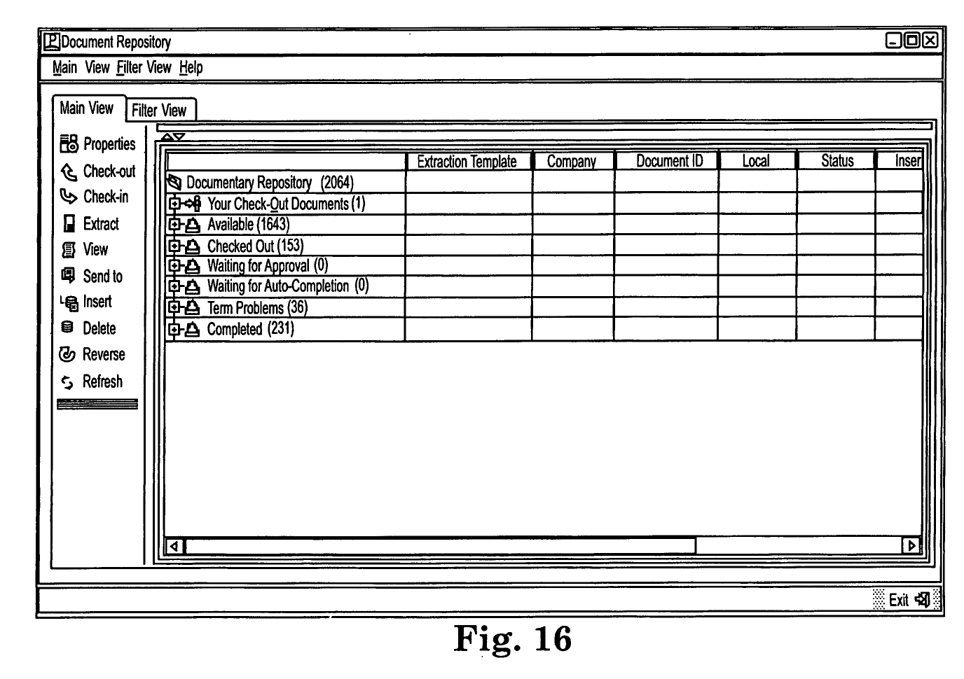

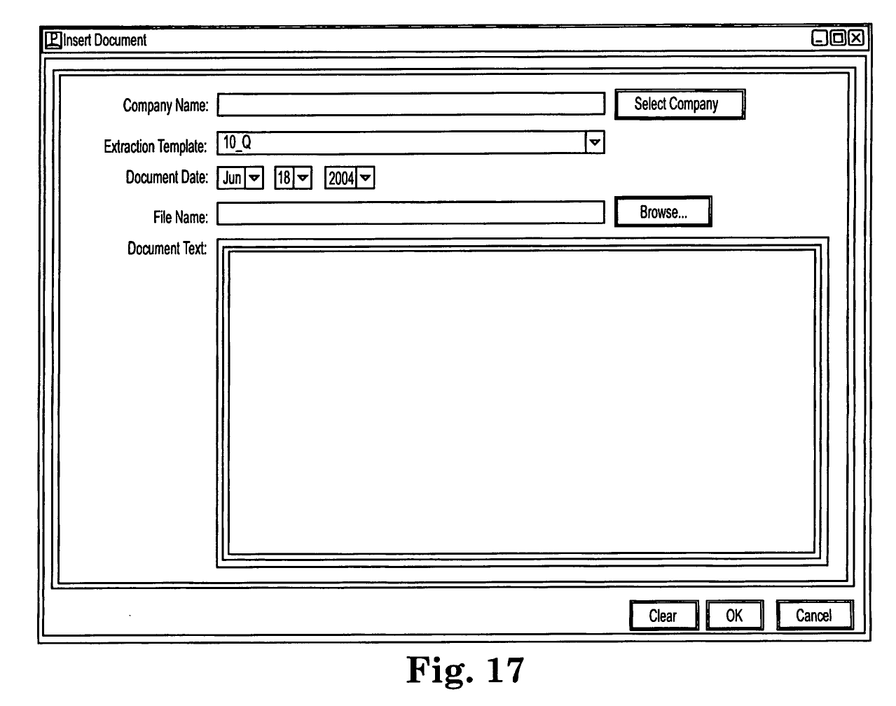

FIG. 16 shows the initial panel of the document repository tool with the “insert” button enabled. Upon launch of the document inserter panel, the user may cut and paste the text of the document into the “Document Text” area or click the “Browse” button to navigate to the file directory location to choose a disk resident document. Each document is attached with an associated naming identifier and a date value by facilities provided in the invention. This permits location of the document within the workflow management environment. In one possible embodiment of a user interface for the invention, as illustrated in FIG. 17, fields are available for values such as company name, SIC code, ticker symbol, and industry.

In the pane depicted in FIG. 17, the user may enter the company name or a partial leading string fragment of this name and request all the actual information to be filled in, for example, SIC, industry, etc., which may be archived in a database in one embodiment of the invention.

### Uniform Data Conversion

In one embodiment of the invention, during the document insertion process and in order to process and present data from disparate document formats (e.g., HTML, PDF, ASCII Plain Text, etc.), the invention converts the data in the documents into a uniform data format. This conversion process is accomplished by (1) examining certain document type identifiers associated with the subject document (for example, the document extension name may, in one embodiment of the invention, be used to determine the document type); (2) using a parser to convert the file format in order to determine certain characteristics of the data within the subject document including, but not limited to, font size, font type, color, etc. (in one embodiment of the invention, metatags found within the document are used to determine these format characteristics); (3) determining the appropriate resolution for the data display output; (4) creating a virtual display of the data display output in computer memory; (5) determining the x-y coordinates of the data format for this virtual display; and (6) serializing the data. In one embodiment of the invention, the serialized data is then used during the text mining term model building process for purposes of document inspection related to term indicators.

### Workflow Management

To support a document processing workflow, one embodiment of the document repository application supplies five folders representing the status or location of a document in the enterprise's data collection process. The folders allow control of “ownership” over a document during the data collection process, using a “checked out” status by way of example only. When the document is manually tagged for data values for the selected terms, it may be passed to a location such as a “Waiting For Approval” folder pending quality validation. Yet another folder reflects those documents that have been “completed” and are ready for use in building text mining term models.

In addition, the document repository applies permission rules to each of the folders, allowing specific rights to perform such tasks as assigning a document to the “Completed” folder, inserting and removing new documents into the document repository and using the text mining term model builder application. The folders shown in Table 1 comprise a preferred embodiment of the document repository:

TABLE 1

| Folder | Description |
|---|---|
| Your Checked-Out | Documents are “checked-out” from the |
| Documents | available documents folder into this |
| | “personal” folder. Conventional |
| | authentication techniques may determine |
| | permissions for document management |
| | rights. |
| Available Documents | This is the general pool of all documents |
| | that are available for single-use check-out |
| | by all users of the invention. |
| Documents Checked Out by | If granted permission by the system |
| Others | administrator, this folder allows the logged |
| | in user to view those documents checked |
| | out by other users. |
| Waiting for Approval | This folder is the repository of documents |
| | that have been manually or automatically |
| | tagged but have not yet been validated for |
| | quality. |
| Completed Documents | Retains all documents that have been |
| | manually or automatically tagged and have |
| | passed an inspection stage. These |
| | documents are used to build the text mining |
| | term models for text mining future |
| | documents of this document type. |
| | Documents in this folder maintain all of |
| | their tagged terms in the relational database |
| | management system as well as an XML file. |

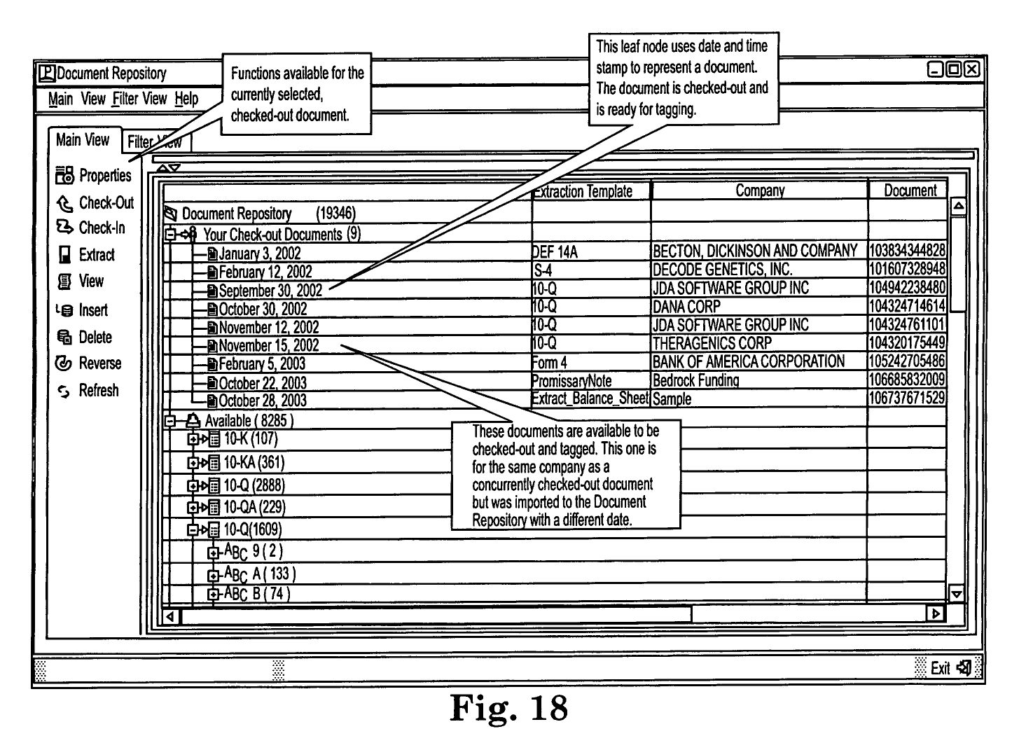

In order to work with a document the user highlights that document after navigating to it within the specified folder. By clicking on the document, the function buttons on the right are enabled as appropriate to features available for the folder category. For example, in FIG. 18, the document highlighted resides in the “Your Checked-Out Documents” folder and cannot be check-out since it already is checked out to the signed-on user. The “Check Out” button appears disabled since the document cannot be checked out twice.

Table 2 describes each of the button actions available based on the context of the selected document in one embodiment of the invention.

TABLE 2

| Button | Action |
|---|---|
| Properties | Displays a read-only view of the document properties |
| | including such facts as the file name of the document residing |
| | on the invention's file server, document type, creation date, |
| | and if it is checked out and, if so, by whom. |
| Check out | The currently highlighted document is placed in the signed-in |
| | users Your checked-out documents folder. This button will |
| | only be enabled when the user highlights a document found in |
| | the Available documents folder and also has permission to |
| | check out documents. |
| Check in | The currently highlighted document is replaced in Available |
| | documents folder. Any pending work done on this document |
| | (any tagging of term data values) is checked-in as well and |
| | available for others to check-out. This button will only be |
| | enabled when the user highlights a document found in the |
| | Your checked-out documents folder. |
| Extract | This button launches the user interface that facilitates the |
| | tagging of data values to their respective term names |
| | (discussed in Mapping Data Values to Their Terms). This |
| | button will only be enabled when the user highlights a |
| | document found in the Your checked-out documents folder |
| | and also has permission to tag documents. |
| View | This button launches the user interface that facilitates the |
| | tagging of data values to their respective term names |
| | (discussed in Mapping Data Values to Their Terms). For all |
| | folders other than the Waiting for approval, the user attains a |
| | read-only view of the document and may not save information |
| | about newly tagged data values. They also may not |
| | AutoExtract a selected term (see the discussion of Auto |
| | Extraction in Extracting Data Values Based on Text Mining |
| | Term Models) |
| Insert | Allows the user to manually add a new document to the |
| | document repository. |
| Delete | When permission allows, the selected document is removed |
| | from the document repository. |
| Reverse | When permission allows, a document that had been completed |
| | may be removed from the “Completed Documents” folder and |
| | placed back into the “Your Checked-Out Documents” folder |
| | for the user who originally checked-out that document. |

### Mapping Data Values to Their Terms

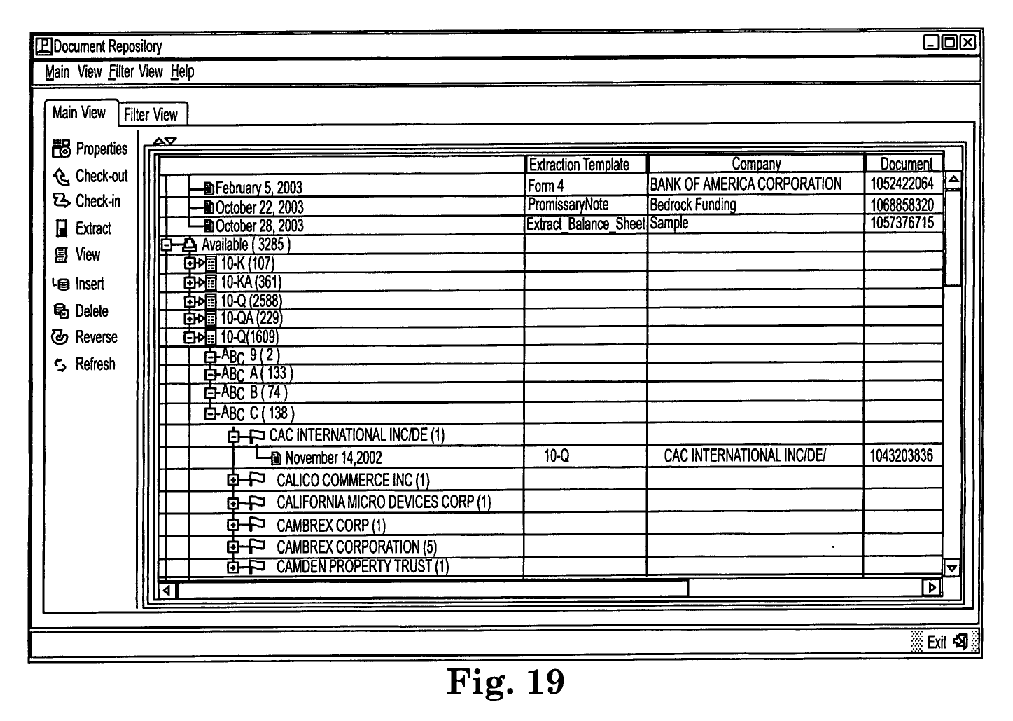

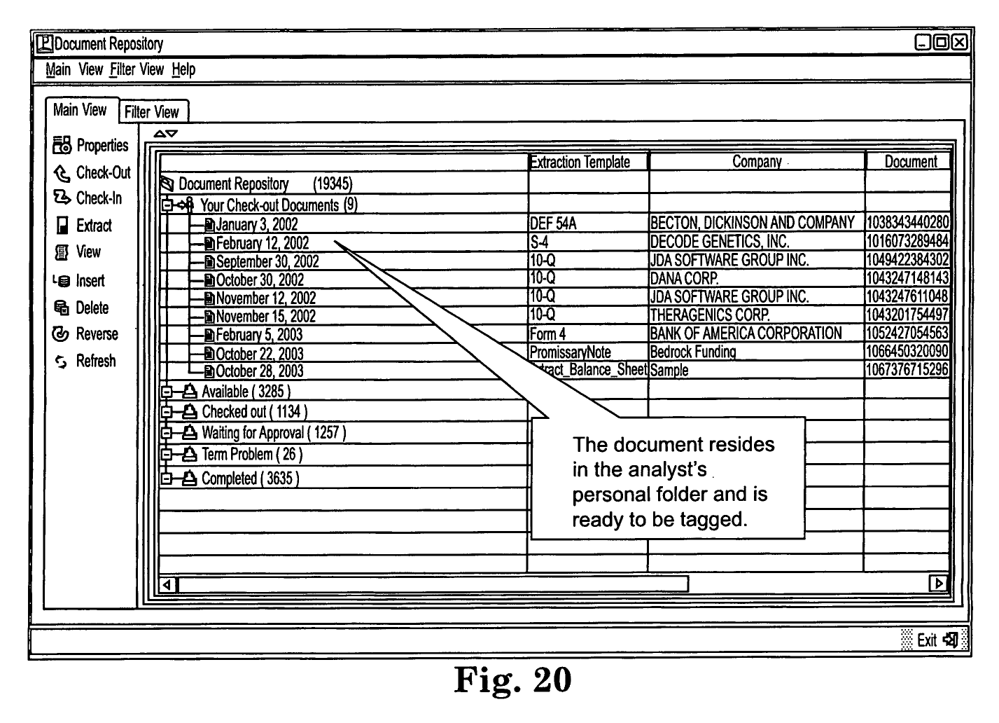

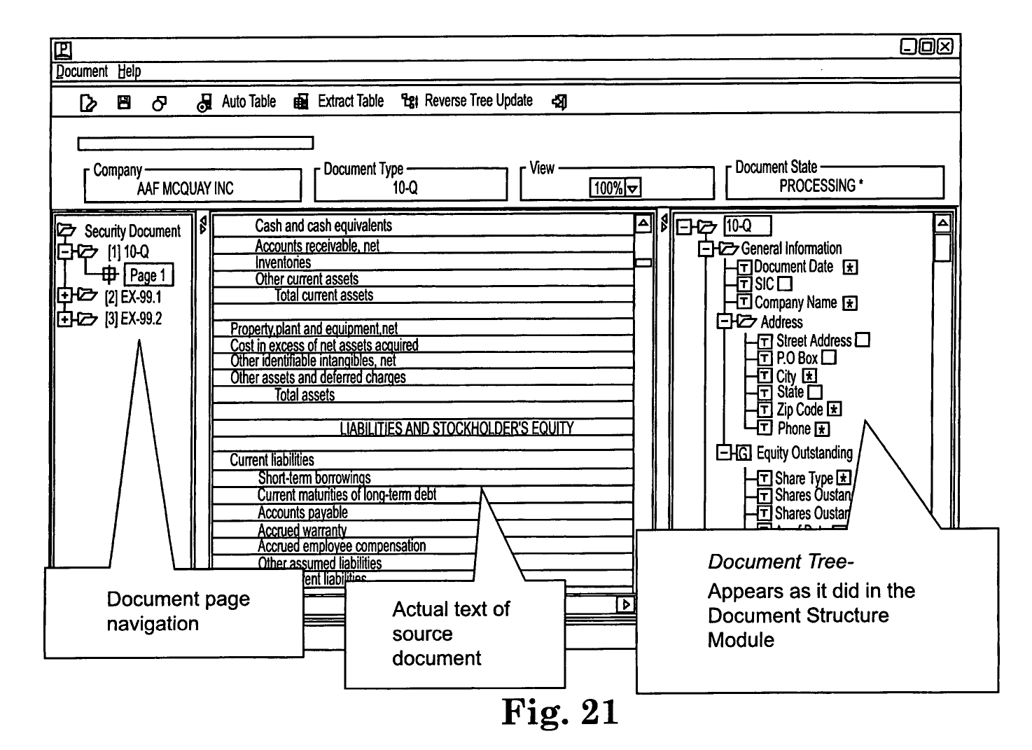

In order to provide the training set of data needed by the text mining term model building process, specific data values found in documents must be tagged to their term names. The document repository module provides a facility to accomplish this goal. The user simply clicks the Extract button on the main document repository panel after navigating the workflow process folders to find the document. Upon clicking the Extract button for the specific document highlighted in the workflow management tree, a user interface (see FIG. 21), as represented in one embodiment of the invention, is presented. FIGS. 19-20 show an example where a specific document from the available documents folder is chosen by “checking the document out” and positioning that document within a “Your Checked-Out Documents” folder in preparation for tagging the document for term-to-values mappings.

A term in the extraction template (see right panel of FIG. 21) is associated with a corresponding value in the source document panel (center panel). The preferred action is to highlight the value found and single-click on the question mark colored or otherwise designated for a term that must be tagged for the document to be completed, or that question mark colored or otherwise designated for a term that need not be tagged for the document to be complete, both as found on the extraction template.

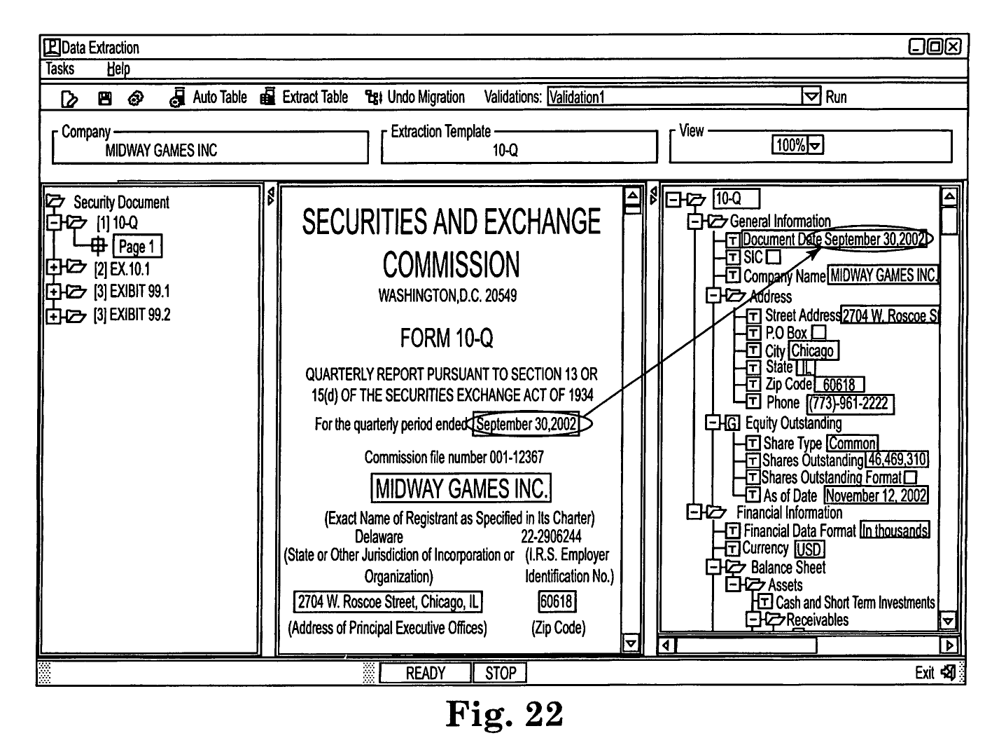

FIG. 22 shows the data visualization effect upon highlighting the text found in the source document panel and clicking on the respective question mark for the term “Seller.”

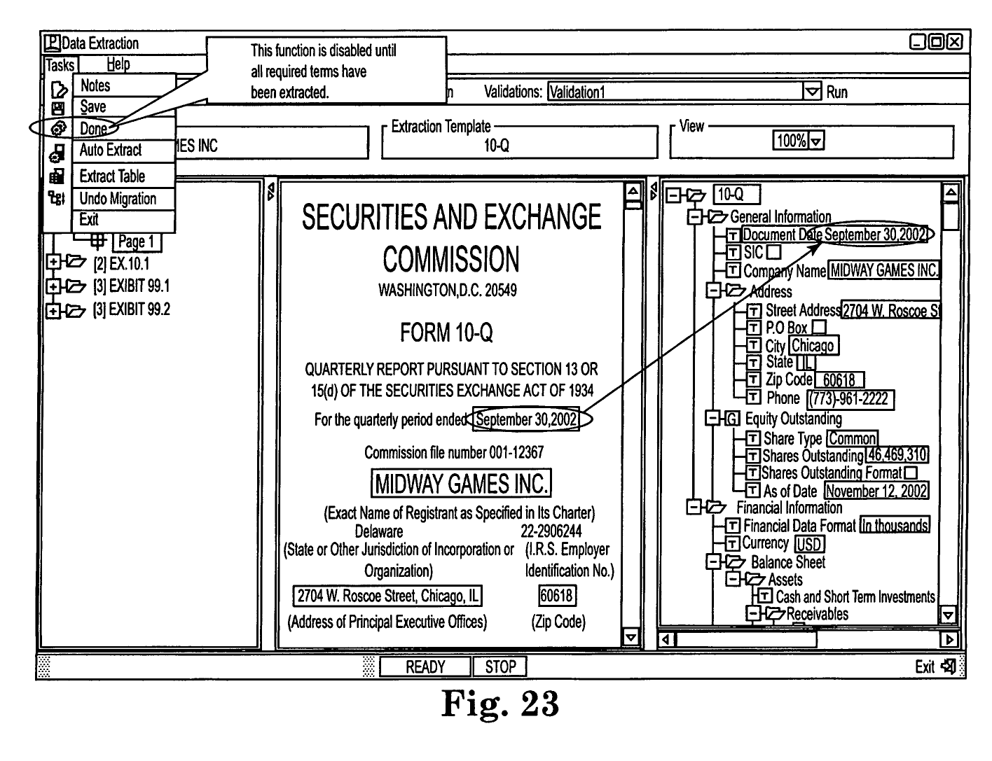

This highlight and click process continues to associate data value mappings for terms found on the extraction template. If needs dictate, only a subset of these terms may be mapped. FIG. 23 shows a document with several of its terms tagged. This document may be ready to be placed in the completed documents folder or the waiting for approval folder based on workflow management permission. If the user who is tagging the document wishes to retain their work for an intermediate time, they may close the document repository module and restart in the future. The current tagging process may be saved by clicking first on the Save and then the Close button. The next time the user returns to the document, they again click on the Extract button from the document repository main panel to launch the application that allows them to review their tagged document, make corrections in tagging, or review work performed.

Table 3 depicts the actions associated with each of the buttons in the preceding figures.

TABLE 3

| Button | Action |
|---|---|
| Notes | Allows entry of notes about the document. These notes may |
| | contain information about specific data values. |
| Save | All work involving the tagging of terms is saved in the |
| | document repository. |
| Done | The document is passed to the next folder in the workflow. |
| | This button is clicked when all the necessary fields have |
| | been tagged to their correct data values. |
| Close | Closes the extraction application and returns the user to the |
| | document repository main panel. |
| AutoExtract | The system will run the process to extract data for each |
| | term possessing a text mining term model that does not |
| | show a data value to the right of the term name in the |
| | extraction template. |
| Extract | The table highlighted in the source document panel is |
| Table | extracted into its component terms. |
| Stop | Immediately halts the automatic data extraction process, |
| | which can take several seconds to several minutes to |
| | complete based on the number of terms and other factors. |

### Extracting Data Values Based on Text Mining Term Models

The user may invoke the text mining term models for one or more terms from within the context of the extraction template. This action can only be invoked upon clicking the Extract button or when the user is viewing a document found in the Waiting for approval folder.

If a text mining term model exists for the term, the pattern recognition text mining term model will attempt to locate the exact data value for the selected term or terms. The user selects the term or branch of the extraction template containing the term, right-clicks and selects AutoExtract from the context menu. If the highlighted extraction template node is a branch, all sub-branches and their contained terms are addressed by the text mining term models. For example, if the user highlights and right-clicks on the root node of the extraction template, all terms found in the extraction template that possess a text mining term model will be processed for data value extraction.

If data is tagged in the extraction template (using the tagging application component of the document repository), the user may clear the values to the right of the term name by right-clicking and choosing the Clear or Clear All menu item. The choice presented when the extraction template node is a branch is Clear All and Clear when the node is a term.

### Context Menu for Terms

Highlighting a term in the extraction template and right-clicking presents a menu allowing the user to perform the actions on a term as specified in Table 4.

TABLE 4

| Menu Item | Action |
|---|---|
| Delete | Deletes the term from current representation of the |
| | document structure. |
| Clear (Clear All) | Clears the values tagged for this term |
| Show History | Shows a record of all values tagged for this term |
| Auto Extract | Runs the text mining term models to extract data |
| | for the highlighted term. |
| Overwrite | Allows the user to overwrite values for the term |
| | effectively assigning text and/or numbers to a term. |

### Customized Document Repository Views

The user may choose to view the contents of the document repository folders organized by various levels. In addition, the user may limit the view of their universe of documents in one embodiment of the invention to, for example, specific companies or industries. This allows the user to consider only, for example, a specific industry. If, for example, only financial documents for transportation and logistics are of interest, only those documents will appear in their view of the document repository. The user may also limit their view to documents that are dated by a specific date range. The complete list of limiting factors available to customize the document repository view is: date range; specific companies; specific industries; specific document types; and specific document states (e.g., located in the “Waiting For Approval” or “Completed Documents” folders).

The user may also rearrange the levels of components seen in the document repository tree. The default view shows the folder associated to the document state followed by the child node, which is the document type, then the company name alphabetical sub-list, the company name and finally the actual document indicated with a document date. The user may customize this taxonomy with the following tree levels: document date; checkout user; document type; company name; and alphabetical sub-list.

### Using the Term Class Tool

When designing a template for the structure of a document, the user may add a validation component to a term. To do this, the user creates a list of acceptable data point values and assigns an identifying name to this list. The identifying name is known as a term class and may be assigned to a term during the document template creation process described above. Different terms may reuse the same term class. The value of this feature comes into play when tagging values to a term. Immediate validation of the value may be performed by a comparison of the list of valid values maintained in the lists of term values and synonyms.

An example of a term class might be “Mineral Resource.” When tagging a document, the user may wish to validate that values comprise a list of only strings such as Au, bullion, Elemental gold etc. when referring to gold. The user tells the system that, for example, Au is a synonym for gold and when the string value “Au” is tagged, the alternate value, Gold, is actually used as the value for the term. In addition to validation of the tagged value, this allows for more uniform data value names that contribute value to the text mining term model building process. In the invention, maintenance of a list of these term values and lists of synonyms is accomplished by using the a term class synonyms maintenance module.

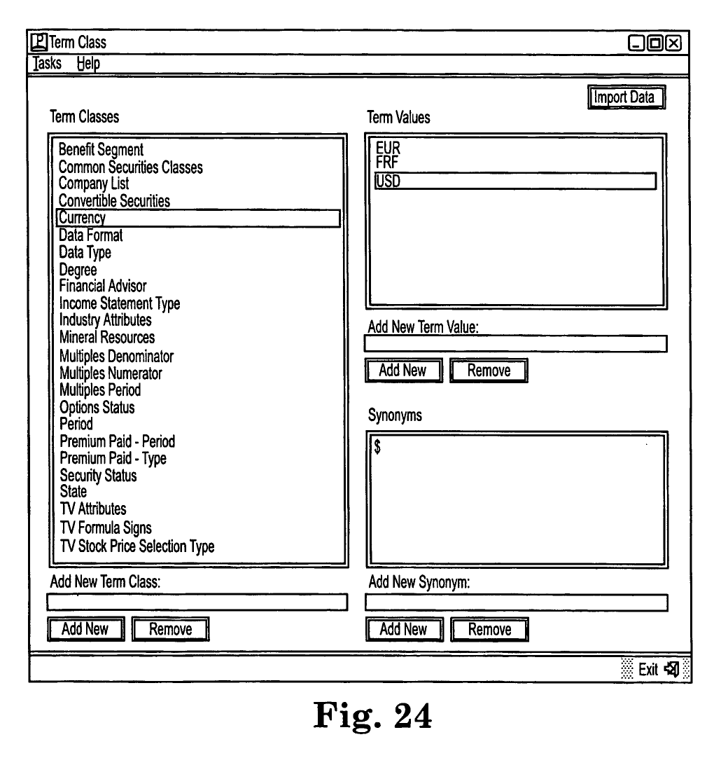

The tool allows the user to add and remove term classes and assign one or more term values. In addition to the validation of a single term, the user may add synonyms that are used during the tagging process to map to term values. The listed term classes can then be used and reused during the template building procedure. When creating new terms, the user may assign a specific term class assuring consistency across document types in addition to providing validation during the tagging process. FIG. 24 shows the values held by the invention after adding term values and synonyms for the term class “Mineral Resource.”

During the term value tagging process, if a specific value is not found by the system, a warning dialog is presented to allow the user to override the validation check or pick from the known list of term values. The default behavior is to allow for the override of term value with the tagged or extracted value. Alternatively, the user may select the appropriate term value from a drop down list that represents all the current term values know by the system. In the case of the later, a phase in the quality control workflow that will be seen later, allows an administrator to veto or accept the new value as a synonym to the selected term value. When accepted by the quality control individual, the new synonym is added to the list of synonyms available for future documents.

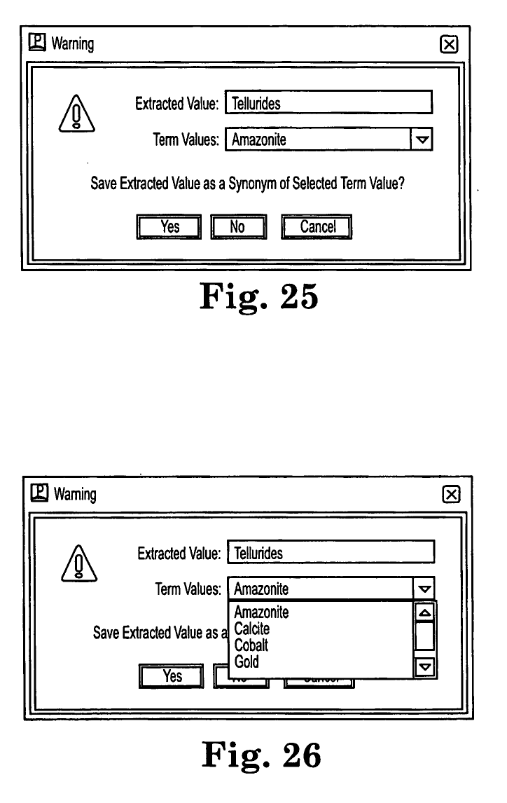

FIGS. 25 and 26 show the dialogs that allow the user to either override the value or select a synonym from the known list of term values. When choosing the option to “Use Synonym Selected Above,” the user assures that the correctly selected, system-understood term values from the drop down list is used. In the case of FIGS. 24 and 25 the user manually extracts the value “tellurides.” Since the database of known “golds” does not contain “tellurides” (as seen in FIG. 24), the user associates the new value to term value “Gold” by selecting “Gold” from the drop down list of term values and clicking on the radio button, “Use Synonym Selected Above.”

### Data Quality Assurance Controls

The invention employs various quality control measures in the data collection processes. These quality control measures function on various levels: document-specific controls; system-wide controls; automated data cross-checks; manual quality assurance measures.

### Document-Specific Controls

Specified Data Types. Each data field to be extracted in a given financial filing is classified as a particular “data type,” i.e., as an integer, numeric (one or more decimal places), string, date, etc. If an attempt is made to extract an incorrect data type for a given field, such as a data extracted in a revenue field, the application will note that such attribute is potentially incorrectly tagged and will not deposit the data into the database. All problematic terms are reviewed, such as by using the term problem resolution module.

Pre-Assigned Values and Synonym Lists. Many of the fields in a given financial filing are assigned a list of values, along with a list of synonyms for each particular value. When information is extracted for such fields, the information must either match one of the pre-assigned values exactly or correspond to one of the approved synonyms. If no such match exists, the application notes that such attribute is potentially “problematic” and does not deposit the data into the database. All problematic terms are reviewed using the term problem resolution application; either the appropriate match from the existing list of values is selected (which thereafter adds the new value as an approved synonym), a new value is added to the permitted synonym list.

Additional Controls. The invention may include additional controls specific to the document type or data type to be extracted. For example, user-specific (even proprietary) validation rules may be created, such as rules for financial statements that require that revenue be greater than net income line, that depreciation be less than total assets, etc. This means that the invention can determine whether a value or ratio has increased or decreased by acceptable (or unacceptable) amounts from a previous period; or if a figure, ratio or growth rate falls outside industry norms (or user-created parameters) as established by prior data extraction sessions. If so identified, the terms are noted as “problematic,” stopped in the workflow management chain of events, and subject to review. Because the validation rules are implemented in software, the rules may be any of the following (alone or in combination): added to the workflow management process at any time; turned off at any time; run upon completion of the auto-extraction process (whether run on a server, a client, or a distributed remote server); or run on any such computers without human interaction. The results of the user-created validation rules may, if desired, control movement of the document extraction data within the workflow process.

### Automated Data Cross-Checks

The invention employs numerous other automated data cross-checks to further ensure data integrity. These cross-checks match and/or compare certain data as extracted to other extracted data contained in the system, allowing for the identification of potential data extraction errors and/or inconsistencies. For example, when examining certain SEC filings company names are matched and/or compared to their respective addresses, telephone numbers and SIC codes as maintained in the system of the invention. If a match does not occur, the system notes that such attribute is potentially “problematic” and does not deposit the data into the database. All problematic terms are reviewed, such as by use of the term problem resolution application. Such issues may indicate that an attempt to extract incorrect data was made, or simply that a change has occurred in the company's information since its last SEC filing.

### Quality Assurance Review Process

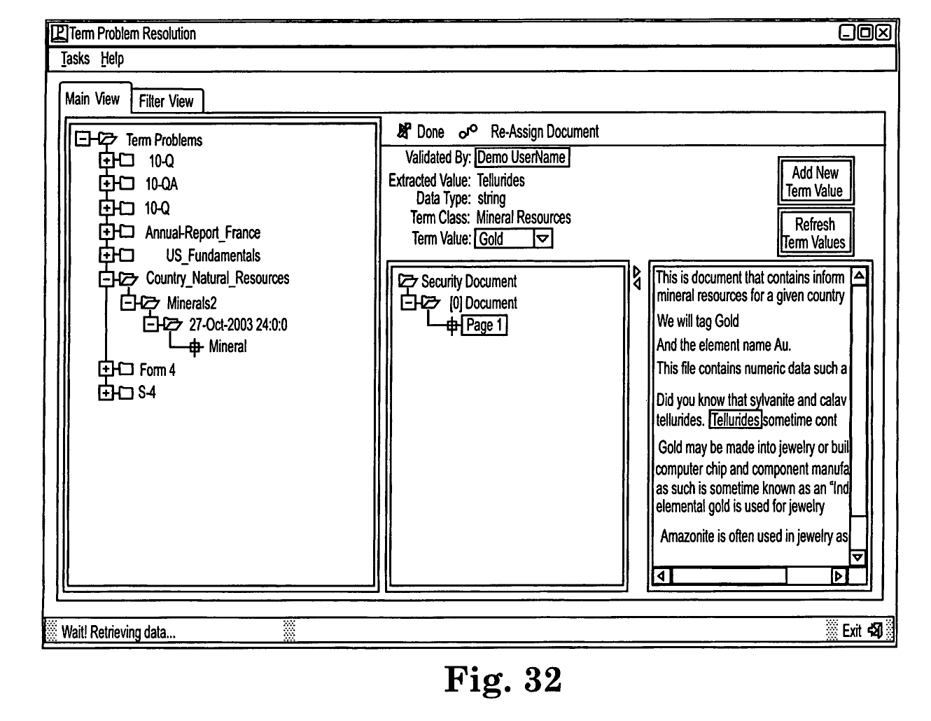

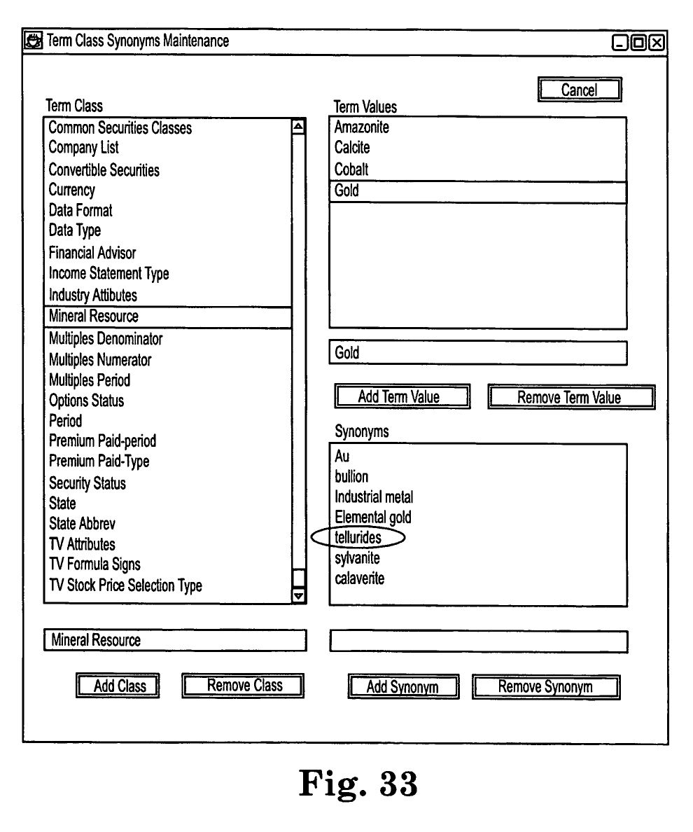

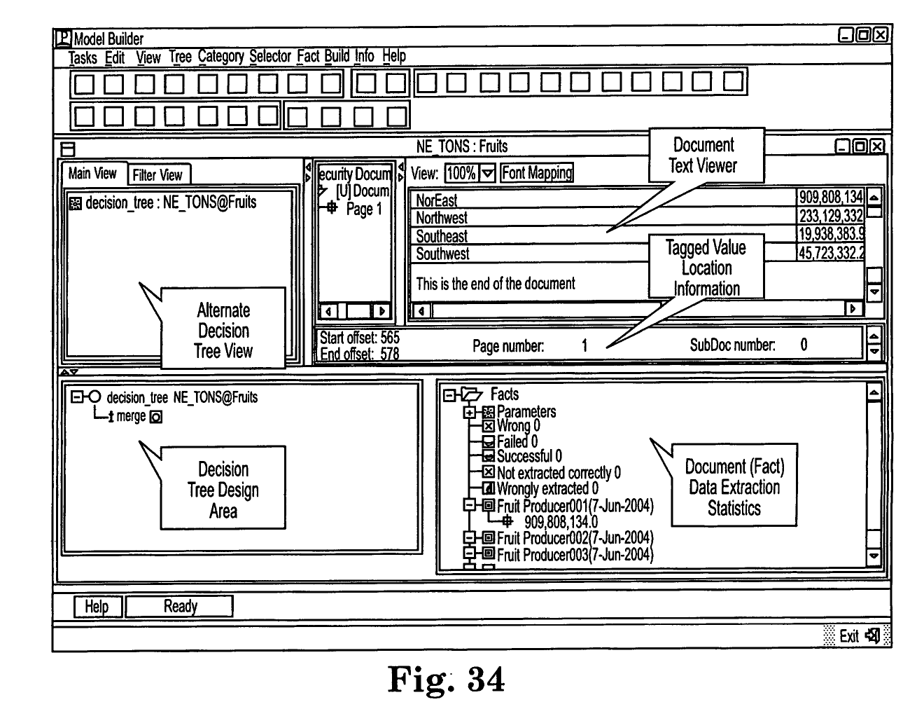

If a user chooses “Override with Extracted Value,” effectively bypassing the check for the valid term value, a process in the quality assurance workflow path will catch this event. The term problem resolution module presents the list of “problematic” terms, as seen for example in FIG. 32. A new term value for the given term class may be created (such as by selecting an existing term class from a drop-down list), or a new synonym for the extracted value for a specific term class may be created. The information is entered in the database upon completion. If the new extracted name is a suitable synonym for a term value, the synonym may be added to the database for that term value. FIG. 34 is an example of how the result of the database for the term class “mineral resource” may be displayed.

### Specialization of Decision Tree Elements

Decision trees are an essential component of the text mining term models found in the invention. Those skilled in the art know that decision trees used for directed text and data mining divide the records in the training set into disjoint subsets, each of which is described by a simple rule. In the invention, two examples (among a plurality of others) of these simple rules may be: Is the target text in a page?; and Is the target text found within a specific table?

One of the chief advantages for the use of decision trees in the invention is that the model lends itself to be explainable since it takes the form of explicit rules. The use of a decision tree format provides the concept of a recognizer for every term with active elements at its branches. These active elements represent key phrases, phrases that are found at specific distances from the target text areas, and regular expressions that assist in selecting a text given a set of patterns. These active elements, in the invention, are called indicators. Every active element serves as a compressive processor. The more non-required indicators for finding the text that are cast away the better. Every element may contain an identifier section determining the relevance of the element to the particular text. Thus a decision tree structure supplies a level of flexibility required for the variety of text situations. In a two-stage parsing process, the first stage called the generic document parsing stage, parses the document into a hierarchy of generic components such as Title, Table of Contexts, Chapter, Appendix, Paragraph, etc. This first stage of parsing is independent from the second stage described below. The goal of the first stage is to decompose a long text into a logically connected set of smaller text elements. The assumption is that the locations of the target semantic elements correlate with the location of generic components. For instance, the semantic element “Comparable Company” would most likely be found in the component “Body of the Document” in the section “Fairness Opinion,” and one would rarely find it in the Title or in the Table of Contents sections. Thus parsing the document into generic components creates additional information that the invention may use for the semantic element search. The second phase in the parsing process, instead of determining if the section contains the value to be found, actually finds the exact data using one of more uses of the active elements. The decision to use these active elements for text extraction (called Feature Extraction) and the optimized use of these active elements are automatically controlled and determined by the invention in the algorithmic component that performs decision tree optimization.

### Feature Extraction

The invention applies a statistical approach to the feature extraction aspects of the invention. The assumption is made that for every semantic element there is a restricted number of text situations or forms in which it can appear. The goal of the invention is to build a system capable of retrieving invariant dependencies for every required semantic element (term).

### Selection of Indicators

The invention selects a wide variety of text indicators including key phrases and other phrases with representative distances from the target data point. From this list of indicators, the invention may use a statistical approach to trim down the list to thirty (in one embodiment of the invention) reliable indicators that are used as a basis for determining independent variables and their values in the algorithm that builds polynomial approximations from the location indication data. The algorithm addresses the main problem of multivariable empirical dependency modeling—searching for an optimal structure of the approximation function. Hence, the invention implements a core classification module representing a hierarchy of categories representing semantic elements of different levels of generality.

Examples of semantic elements or containers or terms include: title—one sentence, located in a separate line, center formatted, preceded and followed by an empty line; sentence—a set of words started from an upper case letter and ended with punctuation marks such a exclamation mark (!), question mark (?), or period (.); narrative—one or more sentences ended with a period; interrogative sentence—a sentence ended with a question mark; exclamatory sentence—a sentence ended with an exclamation mark; paragraph—a list of sentences preceded and followed by empty lines; table—a paragraph having columns, i.e., equal or close distances between phrases in the same row.

### Decision Tree Hierarchy

When generating a model for feature extraction, the parsing of the text document (fact) follows a hierarchy inherent in the decision tree. In the example of a triangle, one may wish to find the hypotenuse of a right triangle. The identity decision determines if the shape has 3 sides for the category triangle. The invariants are either entered by the end user or calculated (optimized) using the evolutionary search algorithms preferred for the invention. By adding invariants, the invention makes use of the ability to parse text using regular expression methods known to those familiar with the art. A sample decision tree is:

Category: is a triangle
Identity: has 3 sides
Invariants
   Invariant: sum of all angles is 180 degrees
   Invariant: area=½ times base times height
   Invariant: area=½ times a times b times sin(C)
Indicator (optional)—best value based on optimization to, for example, find the closest value of sin C.
Selector (optional)

Applied to the practical task of, for example, finding a value in a table for a specific row/column element that has no consistent row/column names or row position (e.g. the feature extraction value may be at the 10^{th} row of a table during one document occurrence or the twelfth row, the thirteenth row, the fourteenth row, etc. at other occurrences), the decision tree might appear as:

Decision Tree

Category: is on a specific page (optimized by decision tree optimizer)
Identity—

Decision Tree

Category: is in a specific table (optimized by decision tree optimizer)
Identity
Invariants
   Invariant: is in a specific column (optimized by decision tree optimizer)
   Invariant: is in a specific row (optimized by decision tree optimizer)
      Indicator: generated factor (independent variable)
      Selector: either a key phrase or distance indicator
   Invariant: is a number matching specific formatting criteria.

The basic technique is “Split and Select” where invariants are used to split incoming text into parts such as pages or tables. The selector is either part of an invariant or may be it's own invariant. The selector is able to select the correct part of the text to make the continuation of the pattern recognition processing easier.

### Decision Tree Serialization and Model Invocation

In order to make the text mining term models portable, the decision tree of each model, including optimization of each invariant (if the invariant is optimized), is stored (or serialized) in a XML file on the server hosting the invention. When a new document is introduced to the invention, this serialized representation of the model is read and executed. The new document is extracted by applying the decision tree rules and by execution of the specified runtime code (with included parameters) as dictated in the XML file. The parameters used include a weight which signifies the “goodness” of the indicator and distance information. In the case where the indicator contains information about distances away from the actual row, column, table, etc., parameters that signify the frequencies of when the text was truly found as well as the relative distances to these indicators are used. This distance and frequency information goes into calculating the relevancy of the indicator.

### Decision Tree Optimization

If used, the optimization of the pattern search follows an approach inspired by Darwin's theory of evolution. Simply said, problems are solved by an evolutionary process resulting in a best (fittest) solution (survivor). In other words, the solution is an evolved one. Hence, the solution of finding the fittest indicators for locating a specific data point in a text document is found by starting with an initial population of solutions and iteratively identifying inviting properties associated with potential solutions to produce subsequent populations of candidate solutions which contain new combinations of these fertile characteristics as derived from candidate solutions in preceding populations. Since evolutionary search algorithms have been shown to be very effective at function optimization, the invention incorporates the approach in it's methods for finding the best polynomial regression expression for a set of given monomials. The set of monomials represent the independent variables (one or more independent variables make up a monomial using multiplicative factors for the independent variables) in the regression model and are referred to as indicators. Use of the idiom, indicator, describes these independent variables to be locations (relative and immediate) for the data point to be extracted from a document. As one versed in the art knows, simple genetic algorithms (GA) and evolutionary search algorithms use three operators in their quest for an improved solution: selection (sometimes called reproduction), crossover (sometimes called recombination), and mutation. These operators are implemented programmatically by the invention to exchange portions of the strings of monomials, add variations to these combinations and choose best fitting solutions (survivors). A brief description of these operators in provided below. The requisite information for a solution to a given problem is encoded in strings called “chromosomes.” Each chromosome is decoded in the invention into strings of monomials representing collections of distance and regular expression text location indicators that are simple strings. The potential solution represented by each chromosome in the population of candidate solutions is evaluated according to a fitness function, a function that quantifies the quality of the potential solution. In the invention, the quantifying factor seen in the minimization of the sum of squares residuals for the various chromosomes allows the invention to converge on a solution that eventually presents the decision tree invariant with optimum indicators for finding a specific data item within the document text. In the context of this preferred embodiment of the invention, the term gene represents each of the monomial groupings. The invention solves the system of simultaneous equations to provide the estimated coefficients and hence the resulting error sum of squares (SSR) and mean square (MSE) and estimated variance. Any of these may be used to find a minimized value, and thus provide the solution to the problem of selecting best indicators (best surviving chromosomes) for finding text in the document.

Table 5 depicts a section of the population or pool of chromosomes.

TABLE 5

| | | Fitness |
|---|---|---|
| | Genes¹ | Solution² |
| Chromosome 1 | (X₃ . . . X₁₃ * X₁₂ . . . X₂₁) | ? What is the |
| | | minimum least |
| | | squares |
| | | estimate |
| Chromosome 2 | (X₃ . . . X₄ * X₁₁ . . . X₂₁ X₂₈) | ? |
| Chromosome 2 | (X₉ . . . X₁₃ * X₁₂ . . . X₂₁) | ? |
| Chromosome n | (X₃ . . . X₁₈) | ? |

¹Each gene is made up of one or more independent variables where greater than one is represented as multiplicative of the other(s).
²Sum of squares error (residuals or sum or squares error per degree of freedom)

Table 5 represents what may be a trimmed down (subset) of possible monomial groupings serving as a starting point for producing candidate solutions. Exact solutions will be those independent variables that represent the best indicators for find text in the given document as determined by the evolutionary search technique. Using the limited set of monomials to achieve the best calculation of a least squares fitting polynomial is programmatically accomplished by the invention. It can be shown mathematically, using some elements of calculus, that these estimates are obtained by finding values of β and β₁ that simultaneously satisfy a set of equations, called normal equations. For example, one may solve a multiple regression model with m partial coefficients plus β₀, (the intercept). The least squares estimates are obtained by solving the following set of (m+1) normal equations in (m+1) unknown parameters:

$${β}_{0} n + {β}_{1} \sum {x}_{1} + {β}_{2} \sum {x}_{2} + … + {β}_{m} \sum {x}_{m} = \sum y , \\ {β}_{0} \sum {x}_{1} + {β}_{1} \sum {x}_{1}^{2} + {β}_{2} \sum {x}_{1} {x}_{2} + … + {β}_{m} \sum {x}_{1} {x}_{m} = \sum {x}_{1} y , \\ {β}_{0} \sum {x}_{2} + {β}_{1} \sum {x}_{2} {x}_{1} + {β}_{2} \sum {x}_{2}^{2} + … + {β}_{m} \sum {x}_{2} {x}_{m} = \sum {x}_{2} y , \\ ⋯$$

$${β}_{0} \sum {x}_{m} + {β}_{1} \sum {x}_{m} {x}_{1} + {β}_{2} \sum {x}_{m} {x}_{2} + … + {β}_{m} \sum {x}_{m}^{2} = \sum {x}_{m} y .$$

where n is the number of training set records (i.e. the number of analyzed documents in the text corpus). The solution to these normal equations provides the estimated coefficients, which are denoted by \hat{β}₀, \hat{β}₁, \hat{β}₂, . . . \hat{β}ₘ.

The calculation of the residuals is stated as:

$${s}_{y \vert x}^{2} = \frac{SSE}{df} = \frac{\sum {( y - {\hat{μ}}_{y \vert x} )}^{2}}{( n - m - 1 )} ,$$

where \hat{μ}_{y|x} are the estimated values (estimated y values), and n is the number of observations or in the case of the invention, the number of documents, m is the number of independent variables, and the denominator degrees of freedom is (n−m−1)=[n−(m+1)] resulting from the fact that the estimated values, \hat{μ}_{y|x}, are based on (m+1) estimated parameters \hat{β}₀, \hat{β}₁, \hat{β}₂, . . . , \hat{β}ₘ.

For polynomial regression (a method for reaching the goal suitable for the invention) the linear model is generalized to a kth degree polynomial expansion (continuous function) leading to the similar equations:

$${a}_{0} n + {a}_{1} {\sum }_{i = 1}^{n} {x}_{i} + … + {a}_{k} {\sum }_{i = 1}^{n} {x}_{i}^{k} {z}_{i}^{k} = {\sum }_{i = 1}^{n} {y}_{i}$$

$${a}_{0} {\sum }_{i = 1}^{n} {x}_{i} + {a}_{1} {\sum }_{i = 1}^{n} {x}_{i}^{2} + … + {a}_{k} {\sum }_{i = 1}^{n} {x}_{i}^{k + 1} = {\sum }_{i = 1}^{n} {x}_{i} {y}_{i}$$

$${a}_{0} {\sum }_{i = 1}^{n} {x}_{i}^{k} + {a}_{1} {\sum }_{i = 1}^{n} {x}_{i}^{k + 1} + … + {a}_{k} {\sum }_{i = 1}^{n} {x}_{i}^{2 k} = {\sum }_{i = 1}^{n} {x}_{i}^{k} y$$

The chromosomes are selected from the population to be parents for crossover (also known as recombination). The problem is how to select these chromosomes. According to Darwin's theory of evolution the best ones survive to create new offspring. There are many methods in selecting the best chromosomes known to those familiar with the art. Examples are roulette wheel selection, Boltzman selection, tournament selection, rank selection, steady state selection and some others.

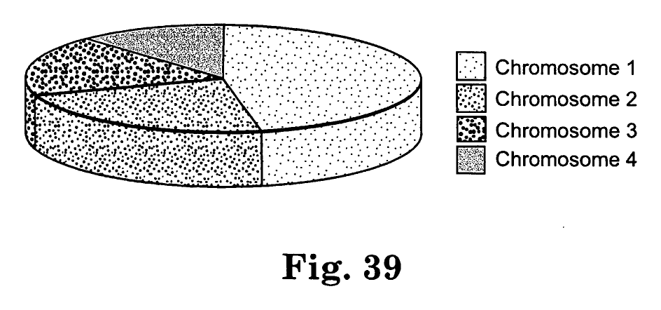

Parents are selected according to their fitness. The better the chromosomes are, the more chances to be selected they have. Imagine a roulette wheel where all the chromosomes in the population are placed. The size of the section in the roulette wheel is proportional to the value of the fitness function of every chromosome—the bigger the value is (in the case of the invention, the smaller the value of the sum of the least squares), the larger the section is. See FIG. 39 for an example.

Using the roulette wheel analogy, a marble is thrown in the roulette wheel and the chromosome where it stops is selected. Clearly, the chromosomes with best fitness value will be selected more times. The general algorithm for the evolutionary search is expressed below and this embodiment or a plurality of similar variations thereof go into the construction of the optimization of invariants in the invention.
1. [Start] Generate random population of n chromosomes (suitable solutions for the problem)
2. [Fitness] Evaluate the fitness f(x) of each chromosome x in the population
3. [New population] Create a new population by repeating following steps until the new population is complete
   1. [Selection] Select two parent chromosomes from a population according to their fitness (the better fitness, the bigger chance to be selected)
   2. [Crossover] With a crossover probability cross over the parents to form new offspring (children). If no crossover was performed, offspring is the exact copy of parents.
   3. [Mutation] With a mutation probability mutate new offspring at each locus (position in chromosome).
   4. [Accepting] Place new offspring in the new population
4. [Replace] Use new generated population for a further run of the algorithm
5. [Test] If the end condition is satisfied, stop, and return the best solution in current population
6. [Loop] Go to step 2

Selection or reproduction is the process in which the monomials (specifically in the invention) or independent variables with high performance indexes receive accordingly large numbers of copies in the new population. Recombination is an operation by which the attributes of two quality solutions are combined to form a new, often better solution. Mutation is an operation that provides a random element to the search. It allows for various attributes of the candidate solutions to be occasionally altered. Mutation is very much a second-order effect that helps avoid premature convergence to a local optimum. Changes introduced by mutation are likely to be destructive and will not last for more that a generation or two. Given the coding scheme of the invention, a fitness function and the genetic operators, it is rather straightforward to mimic natural evolution to effectively drive the selection of the groups of monomials toward near-optimal solutions. The basis of using an evolutionary search method in preferred embodiments of the invention is the continual improvement of the fitness of the population by means of selection, crossover, and mutation as genes are passed from one generation to the next. After a certain number of generations (in preferred embodiments of the invention, hundreds), the population of chromosomes representing choice pattern recognition indicators evolves to a near-optimal solution. The evolutionary search technique for finding these best indicators does not always produce the exact optimal solution, but it does a very good job of getting close to the best solution, quickly, especially for the limited amount of computer processing time that is acceptable for optimizing solutions for text mining applications. Being close to the best solution still yields actionable results.

### Catch Estimation

A software component called a catch estimator is provided by the invention to allow the user to create partial text mining term models and test the results against a document that had been introduced to the invention's optional document repository. When used, the actual data value (feature extraction) is not returned to the user, however, the decision tree paths that bring the invention closer to the goal of feature extraction as possible are traversed. This allows the user to fine-tune and analyze the decision tree traversal process, and validate the indicator optimizations. The models can be run against the set of training data to see the likeliness of reaching 100% accuracy (success in every document) in finding the true value of the target data point. This allows for a process of iterative design of the text mining term model.

### Manual Model Building Process

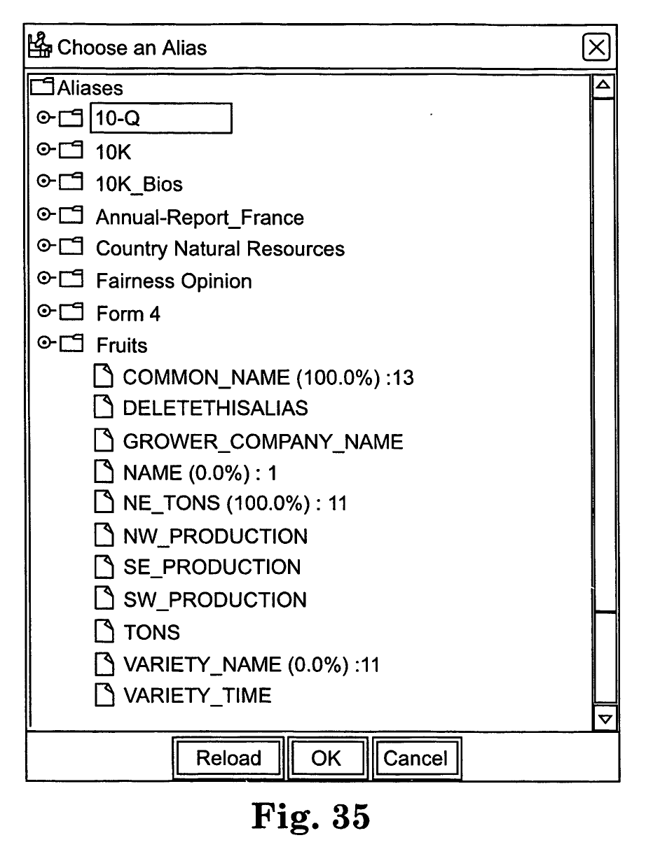

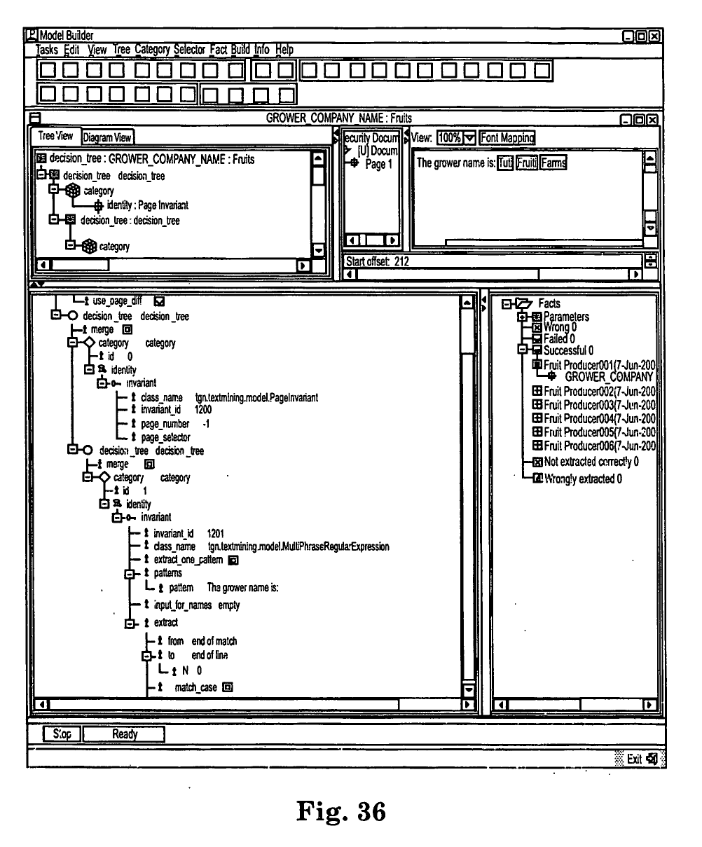

When not done in a fully automated process (e.g., a wizard as described above), the user may manually design the decision tree and create indicator optimizations, such as by use of a GUI depicted in FIG. 35. The GUI consists of a menu area that allows the user to layout the decision tree, create, and optimize appropriate invariants. The user begins by selecting a specific term from a menu of available terms for a document type. This menu is depicted in FIG. 36. When the term name (signified by “Alias” name) is chosen, the GUI is presented with a minimum decision tree and the user proceeds to build onto that tree. The facts (documents) that encompass the training set of all documents are presented in a GUI panel of the invention to allow the user to inspect the tagged values and inspect the various tables, paragraphs and pages that go into making up the training set of documents. The user selects from the various icons found in the GUI to build the decision tree and include invariant types to the various nodes of the decision tree. For example, the user may select the “Add Tree” icon by clicking on it or alternatively selecting the menu item listed under “Tree.” The user proceeds to add invariants to hone in on the requested text area to extract. In this simplified example, the user adds an invariant to locate the text in the first page of the document, and “teaches” this invariant to find the text string used as the indicating string for the “grower name.” The user adds the page indicator invariant, the code class of which is found in a package called tgn.textmining.model.PageInvariant.

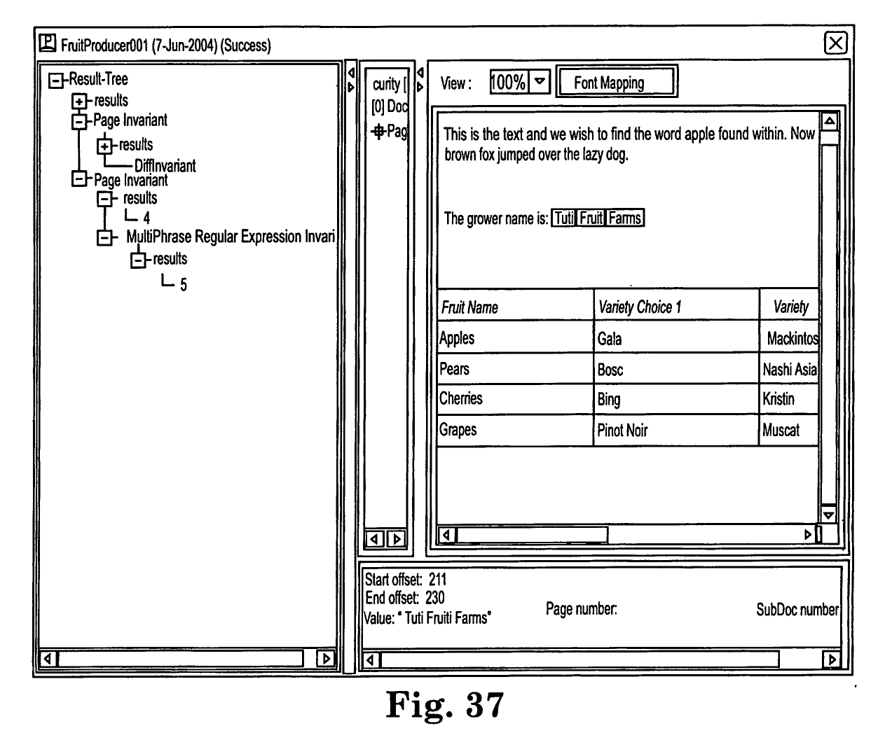

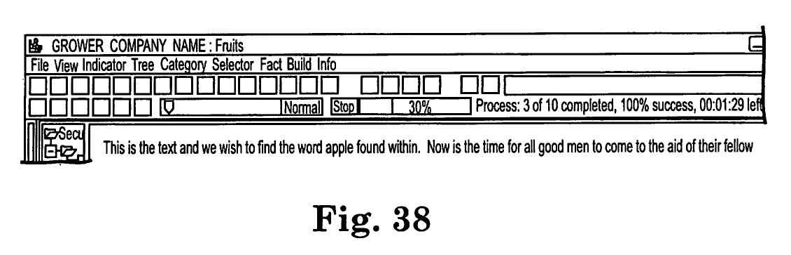

Then the user adds the regular expression invariant and chooses to hard-code the pattern as “The grower name is:” The results of these actions can be seen in FIG. 37. The user may test the intermediate results by clicking on the “Set Catch Estimator” icon, and double-clicking on one of the facts (document group representations). The user is presented with a GUI that indicates the current “correctness” of the model. FIG. 38 shows that this trivial example of a model is capable of navigating to a text string as shown by the “Success” indicator in the title bar. To disable the catch estimator feature, the user clicks again on the icon and resumes the process of building the text mining term model adding more invariant selectors where appropriate. Additional menu items are provided by the invention to save the text mining term model to disk and to load different models into the GUI. An icon (and alternative menu item) is provided to run the decision tree invariant optimization program to invoke the evolutionary search for the best indicators for text retrieval. By clicking on the “Process Facts” icon, the user indicates to the invention that he wishes to run the model against all the documents (facts) or training set of documents. This gives the user an indication of how well the model works against all of the documents that have been manually trained for use as the basis of the set of training documents. If the data value had not been manually tagged in one or more of the facts, a count value for “correctly not extracted” would be indicated for that fact (document).

### Use of Similar Document Specific Memory

In order to better the goal of finding the correct data point, the invention implements a method of retaining specific information about a set of documents that may serve as a template for new document introduction. The newly introduced document is compared with a pattern represented by the specific information that is known to be suitable for searching for text based on the learned pattern found in the set of similar documents (typically but not necessarily documents in the training data set, or documents subsequently processed by the invention). If the patterns are similar (within a threshold), then the task of finding the data values (feature extraction) is facilitated by being more highly correlated to known models based on templates.

One preferred application of similar document specific memory is “company specific” memory, i.e., the knowledge that a given company will employ similar (if not identical) patterns for subsequent versions of similar documents (e.g., subsequent quarterly reports). In this preferred embodiment, the common feature in the set of documents is the identity of the company to which the documents pertain.

### Automatic Model Building

One preferred feature of the invention is the ability to create the decision tree structures and invariant optimizations without computer/human interaction. Based solely on the training set of document manual extractions, the invention may accomplish the tasks needed to create the text mining term model and produce the success/failure indications needed to assure the quality of these models. This feature may be performed based on scheduled time intervals. As more and more documents are added to the document repository, each successive automatic model rebuild makes the text mining term model more robust in its ability to find data values for terms in future documents.

### Self-Learning Engine (SLE) and Text Mining Term Model Rebuild Assessment

The self-learning engine of the invention is an optional (regularly or irregularly) scheduled batch process that acts on the optimized invariants that are incorporated into existing models. As more documents of a specific document type are introduced to the system, the SLE analyzes these documents to ascertain the necessity of updating a model. The logic for the model update trigger follows:

The model accuracy is saved in a separate table. The formula for accuracy is:
Accuracy=100%(1−N_{QA fixes}/N_{extracted}),
where
N_{QA fixes} is the number of manually tagged and fixed terms done by the QA Team since the last model optimization;
N_{extracted} is the total number of extractions made by the model during the same time period.

The invention's trigger for the re-optimization process follows the criterion of:
Last Saved Accuracy−Accuracy>Threshold
where
Threshold is system configurable and set at 0% as the default setting.

In other embodiments of the invention, the text mining term model may be updated repeatedly, as required, or periodically.

It will be apparent to those skilled in the art that the disclosed embodiments of the invention may be modified in numerous ways and may assume many embodiments other than the preferred form specifically set out and described above. In particular, the invention may be implemented as a set of application programming interfaces (APIs) invoked by a programming environment, including (without limitation) Java, C, C++, and Visual Basic. It is possible for the programming environment to provide either the initial document, or the subsequent semi-structured document, or both, to the invention. Alternatively, the programming environment may use the optimized text mining term model by invoking it through an appropriate API. Similarly, the programming environment may receive information extracted from the subsequent document through an API, and thus view extracted data and information about other parameters such as document status, data regarding users of the invention, and so on. Also, auto-extraction of data may be performed on a client (e.g., a desktop or laptop or equivalent) computer, a remote server computer, a mix of both, or any other computer that may be used to implement the invention via internet protocol (IP) or equivalent communications protocols and techniques. Thus, the invention is highly scalable and supports load balancing of the server component that facilitates distribution of the auto-extraction process among more than one computer. This allows the auto-extraction process to be invoked simultaneously on these distributed computers, which reduces processing time for multiple document extractions.

1-118. (canceled)

119. A method for automating the extraction of information from a semi-structured document characterized by a document type that comprises design and structural characteristics of a set of similar documents, the method comprising: designing a target extraction template for the terms of the document type; supporting the creation of a control set of documents containing the terms manually tagged to the extraction template; automatically generating a skeleton of extraction model tree for every term; training the models by automatically optimizing selectors of the term extraction models to the best compliance with the control set tagging; and using the optimized model to automatically extract information from the document.

120. The method of claim 119, further comprising using specialized invariants to select generic components of information from the document.

121. The method of claim 119, further comprising tracking and analyzing changes made to initially extracted information and subsequent re-optimization of models.

122. The method of claim 119, further comprising analyzing an additional semi-structured document and updating the model selectors or its structure if a change in accuracy of the term extraction model exceeds a threshold.

123. The method of claim 119, further comprising: (a) retaining specific information about a set of semi-structured documents to serve as a template for new semi-structured document introduction; (b) comparing any new semi-structured document with a pattern represented by specific information known to be suitable for searching for text based on the retained specific information about the set of semi-structured documents; (c) assessing if the result of (b) is within a threshold of the result of (a).

124. The method of claim 123, as applied to knowledge that a given company employs similar patterns for subsequent versions of similar documents identifying the company to which the documents pertain.

125. The method of claim 119, in which terms can be assigned a term class for at least one of immediate validation, synonym support, and vocabulary management.

126. The method of claim 119, further comprising automatically comparing first and second extracted data to each other to identify extraction errors.

127. A method of manually tagging and extracting terms from a semi-structured document while automatically collecting key indicators for pattern recognition, in which the tagging is the sole generation point of statistics needed for creation and optimization of an extraction model.

128. A method of using an extraction template having terms to extract data from a semi-structured document having tagged values, comprising providing at least one of: a many-to-many relationship between the tagged values and the terms in the extraction template; a many-to-one relationship between the tagged values and a single term; or a one-to-may relationship between a single tagged value and a plurality of multiple terms.

129. A method of extracting data from a semi-structured document having a source format, comprising providing a generalized spatial and contextual file format that is independent of the source format.

130. The method of claim 129, in which the generalized spatial and contextual file format specifies at least one of context on the document, page, table, row, column, and offset.

131. The method of claim 129, in which the semi-structured document is an EDGAR electronic filing and the method further comprises providing at least one of access, navigation, selection, downloading, conversion into the generalized format, and insertion into a document repository.

132. The method of claim 129, in which the semi-structured document is in a format selected from the group consisting of PDF, HTML, and text, and the method further comprises providing at least one of access, navigation, selection, downloading, conversion into the generalized format, and insertion into a document repository.

133. A method of extracting data from a semi-structured source document, comprising providing source links for extracted data at a term level without modifying the source document, and further in which reference to the source document is provided through an abstraction enabled by a generalized intermediate format.

134. A method of quality control in a process of collecting data from a semi-structured source document, comprising providing at least one of document-type specific controls; system-wide controls; automated data cross-checks; and
manual quality assurance measures.

135. The method of claim 134, in which the document-type specific controls are applied to the extracted content and include at least one of validation of specific data types, application of pre-assigned values, referencing of synonym lists, and application of user-defined validation rules.

136. The method of claim 134, in which providing automated data cross-checks comprises automatically cross-checking currently extracted data against previously extracted data to identify potential data extraction errors.
